(19) United States
(12) Patent Application Publication
(10) Pub. No.: US 2026/0302209 A1
(43) Pub. Date: Oct. 1, 2026

(54) POSITIVE ELECTRODE ACTIVE MATERIAL FOR NONAQUEOUS ELECTROLYTE SECONDARY BATTERY, AND NONAQUEOUS ELECTROLYTE SECONDARY BATTERY

(71) Applicant: BASF SE, Ludwigshafen am Rhein (DE)

(72) Inventors: Zhenji HAN, Yamaguchi (JP); Jumpei NAKAYAMA, Yamaguchi (JP); Daisuke MORITA, Yamaguchi (JP); Masatoshi MATSUMOTO, Yamaguchi (JP); Kazumichi KOGA, Yamaguchi (JP); Kazutoshi MATSUMOTO, Yamaguchi (JP)

(21) Appl. No.: 19/477,312

(22) PCT Filed: Apr. 30, 2024
(86) PCT No.: PCT/EP2024/061904

§ 371 Date: Oct. 21, 2025

(30) Foreign Application Priority Data
May 2, 2023 (JP) 2023-076374

(51) Int. Cl. H01M 4/525; H01M 4/02; H01M 4/36

(52) U.S. Cl. CPC H01M 4/525; H01M 4/362; H01M 2004/028; H01M 2300/0017

(57) ABSTRACT

Disclosed herein is a positive electrode active material for a nonaqueous electrolyte secondary battery represented by Li[Liₓ(Ni_{1-y-z-w}Co_{y}Mn_{z}M_{w})₁₋ₓ]O₂ (M is one or more elements other than Li, Ni, Co, Mn, and 0; −0.1≤x≤0.15, 0≤y≤0.4, 0≤z≤0.4, and 0≤w≤0.1), and has a first peak and a second peak within a temperature range of 150° C. to 350° C. when a DTG curve of a sample, charged using lithium as the counter electrode, separated into a plurality of peaks, wherein the top of the first peak shows the greatest DTG value and the top of the second peak shows the greatest DTG value among peaks whose peak tops occur at a temperature at least 20° C. different from the temperature at which the top of the first peak occurs, and the DTG value at the top of the first peak is 1 to 9 times the DTG value at the top of the second peak.

### TECHNICAL FIELD

The present disclosure relates to a positive electrode active material for a nonaqueous electrolyte secondary battery as well as to a nonaqueous electrolyte secondary battery.

### BACKGROUND

Lithium ion secondary batteries have the advantage of being small and lightweight as well as having a high energy density, a high charge/discharge voltage, and a substantial charge/discharge capacity, and have thus garnered attention as power sources for operating AV devices or personal computers and other such electronic devices.

Flammable organic solvents are ordinarily used primarily as electrolytes in lithium ion secondary batteries, and high thermal stability is therefore a requirement. It is known, for example, that when lithium ion secondary batteries are in a charged state, heat is generated, and as a result, oxygen is released from the positive electrode active material crystals, but that this oxygen reacts with the electrolyte, resulting in thermal runaway.

In particular, active materials containing Ni, Co, and Mn have been widely used recently as positive electrode active materials. As the Ni content in this sort of positive electrode active material increases, the phase transition reaction of the positive electrode active material occurs in lower temperature regions, and oxygen is released more rapidly, resulting in a greater likelihood of thermal runaway. On the other hand, there is growing demand for materials having a greater battery capacity and a high Ni content, which has led to a trend toward a loss of the inherent thermal stability of materials that have a high Ni content.

To control such thermal runaway in positive electrode active materials, Patent Document 1, for example, has proposed a positive electrode active material comprising a lithium-transition metal composite oxide that contains 80 mol % or more of Ni and 0.1 mol % to 1.5 mol % of B relative to the total number of mols of metal elements, excluding Li, wherein B and at least one element (M1) selected from Groups 4 to 6 are present on at least the surface of particles of the lithium-transition metal composite oxide, and the molar fraction of M1 relative to the total number of mols of metallic elements, excluding Li, on the surface of particles having a volume-based particle size smaller than 30% is greater than the molar fraction of M1 relative to the total number of mols of metallic elements, excluding Li, on the surface of particles having a particle size greater than 70%. Patent Document 1 states that the use of this kind of composite oxide in lithium ion secondary batteries allows the self-heating rate to be controlled even at elevated temperatures.

### SUMMARY OF THE INVENTION

In the positive electrode active material of Patent Document 1, the surface of the positive electrode active material particles is coated with a boron compound, which can thus be anticipated to control, to some extent, thermal runaway resulting from the reaction between the electrolyte and the oxygen released from the positive electrode active material, but this alone is not enough to control thermal runaway, and there is still room for improvement.

There is thus still a need for a method, other than the method of coating the surface of the positive electrode active material with a compound as noted above, that would control thermal runaway.

In light of the circumstances noted above, the present disclosure is intended to provide a positive electrode active material capable of controlling thermal runaway in nonaqueous electrolyte secondary batteries, as well as a nonaqueous electrolyte secondary battery in which the positive electrode active material is employed.

The inventors engaged in extensive research to solve the problems noted above. As a result, it was discovered that the maximum rate of oxygen release from a positive electrode active material (referred to below as “maximum oxygen release rate”) can be curbed and that thermal runaway can also be curbed when a nonaqueous electrolyte secondary battery utilizes a positive electrode active material comprising a composite oxide that is represented by general formula Li₁₊ₓNi_{1-y-z-w}Co_{y}Mn_{z}M_{w}O₂ (where M is 1 or more elements other than Li, Ni, Co, Mn, O; and −0.1≤x≤0.15, 0≤y≤0.4, 0≤z≤0.4, and 0≤w≤0.1), and that has a first peak and a second peak within a temperature range of 150° C. to 350° C. when a derivative thermogravimetric curve is obtained after a sample of the composite oxide, that has been charged to 4.30 V using lithium as the counter electrode, is heated from 50° C. to 600° C. at a rate of 5° C./min, and the resulting curve is separated into a plurality of peaks, wherein the top of the first peak shows the greatest derivative thermogravimetric value and the top of the second peak shows the greatest derivative thermogravimetric value among peaks whose peak tops occur at a temperature at least 20° C. different from the temperature at which the top of the first peak occurs, and the derivative thermogravimetric value at the top of the first peak is 1 to 9 times the derivative thermogravimetric value at the top of the second peak.

### DETAILED DESCRIPTION OF THE INVENTION

Specifically, the present disclosure provides the following.
(1) A positive electrode active material for a nonaqueous electrolyte secondary battery, that comprises a composite oxide represented by general formula Li₁₊ₓNi_{1-y-z-w}Co_{y}Mn_{z}M_{w}O₂ (where M is 1 or more elements other than Li, Ni, Co, Mn, O; and −0.1≤x≤0.15, 0≤y≤0.4, 0≤z≤0.4, and 0≤w≤0.1), and that has a first peak and a second peak within a temperature range of 150° C. to 350° C. when a derivative thermogravimetric curve is obtained after a sample of the composite oxide, that has been charged to 4.30 V using lithium as the counter electrode, is heated from 50° C. to 600° C. at a rate of 5° C./min, and the resulting curve is separated into a plurality of peaks, wherein the top of the first peak shows the greatest derivative thermogravimetric value and the top of the second peak shows the greatest derivative thermogravimetric value among peaks whose peak tops occur at a temperature at least 20° C. different from the temperature at which the top of the first peak occurs, and the derivative thermogravimetric value at the top of the first peak is 1 to 9 times the derivative thermogravimetric value at the top of the second peak.
(2) The positive electrode active material for a nonaqueous electrolyte secondary battery according to (1), wherein, in the composite oxide, 0<x≤0.15.
(3) The positive electrode active material for a nonaqueous electrolyte secondary battery according to (1) or (2), wherein the derivative thermogravimetric value at the peak top of the first peak is 3%/min or less.
(4) A nonaqueous electrolyte secondary battery comprising a positive electrode that contains a positive electrode active material according to (1) or (2).

According to the present disclosure, it is possible to provide: a positive electrode active material that allows thermal runaway to be curbed when used in a nonaqueous electrolyte secondary battery; and a nonaqueous electrolyte secondary battery using the positive electrode active material.

### BRIEF DESCRIPTION OF THE DRAWINGS

FIG. 1 is a DTG curve of a sample of the composite oxide material of Example 1.

FIG. 2 is a DTG curve of a sample of the composite oxide material of Example 2.

FIG. 3 is a DTG curve of a sample of the composite oxide material of Example 3.

FIG. 4 is a DTG curve of a sample of the composite oxide material of Example 4.

FIG. 5 is a DTG curve of a sample of the composite oxide material of Example 5.

FIG. 6 is a DTG curve of a sample of the composite oxide material of Example 6.

FIG. 7 is a DTG curve of a sample of the composite oxide material of Example 7.

FIG. 8 is a DTG curve of a sample of the composite oxide material of Example 8.

FIG. 9 is a DTG curve of a sample of the composite oxide material of Example 9.

FIG. 10 is a DTG curve of a sample of the composite oxide material of Example 10.

FIG. 11 is a DTG curve of a sample of the composite oxide material of Example 11.

FIG. 12 is a DTG curve of a sample of the composite oxide material of Example 12.

FIG. 13 is a DTG curve of a sample of the composite oxide material of Example 13.

FIG. 14 is a DTG curve of a sample of the composite oxide material of Comparative Example 1.

### EMBODIMENT

Embodiments of the present disclosure are described below, but the present disclosure is not limited in any way by the description of the embodiments and can be worked with additional modifications, as appropriate.

The positive electrode active material for a nonaqueous electrolyte secondary battery in embodiments of the present disclosure comprises a composite oxide represented by general formula Li₁₊ₓNi_{1-y-z-w}Co_{y}Mn_{z}M_{w}O₂ (where M is 1 or more elements other than Li, Ni, Co, Mn, and O; and −0.1≤x≤0.15, 0≤y≤0.4, 0≤z≤0.4, and 0≤w≤0.1), and has a first peak and a second peak within a temperature range of 150° C. to 350° C. when a derivative thermogravimetric curve is obtained after a sample of the composite oxide, that has been charged to 4.30 V using lithium as the counter electrode, is heated from 50° C. to 600° C. at a rate of 5° C./min, and the resulting curve is separated into a plurality of peaks, wherein the top of the first peak shows the greatest derivative thermogravimetric value and the top of the second peak shows the greatest derivative thermogravimetric value among peaks whose peak tops occur at a temperature at least 20° C. different from the temperature at which the top of the first peak occurs, and the derivative thermogravimetric value at the top of the first peak is 1 to 9 times the derivative thermogravimetric value at the top of the second peak.

When oxygen is released from a positive electrode active material over a plurality of mutually separate temperature zones, less oxygen is released per temperature zone than when oxygen is released from the positive active material in only one narrow temperature zone, resulting in less reaction with the electrolyte and less generation of heat. Thermal runaway of the positive electrode active material can therefore be curbed by ensuring that oxygen is released from the positive electrode active material over a plurality of mutually separate temperature zones.

Upon TG analysis of composite oxides, the inventors confirmed via TG-MS that nearly all weight loss at temperatures up to around 350° C. was caused by the release of oxygen. As a result, even though oxygen is released from the positive electrode active material at temperatures ranging from 150° C. to 350° C., the positive electrode active material does not undergo any other reactions within that temperature range. Accordingly, oxygen is released from a positive electrode active material over a plurality of mutually temperature zones when a derivative thermogravimetric curve (referred to below as “DTG curve”) of a positive electrode active material is separated into a plurality of peaks, and has a first peak, which is the greatest, and second peaks, that are separated from each other by a temperature of at least 20° C., within a temperature range of 150° C. to 350° C., where the size of the first peak is no more than 9 times the size of the second peaks.

On the other hand, when a DTG curve cannot be separated into a plurality of peaks (consists of a single peak), or can be separated into a plurality of peaks but the first peak is much larger than the second peaks, oxygen is released from the positive electrode active material in a single narrow temperature zone, resulting in a greater likelihood of thermal runaway.

The requirements for ensuring that a positive electrode active material will show this sort of DTG curve involve many factors, such as the composition, crystal structure, crystallinity, and conditions of synthesis of the positive electrode active material, and can also vary depending on the balance of these factors. Examples of materials that tend to exhibit such a DTG curve include composite oxides represented by general formula Li₁₊ₓNi_{1-y-z-w}Co_{y}Mn_{z}M_{w}O₂ (where M is 1 or more elements other than Li, Ni, Co, Mn, and O; and −0.1≤x≤0.15, 0≤y≤0.4, 0≤z≤0.4, and 0≤w≤0.1), but even if a material has such a composition, the two prescribed peaks of the DTG curve may not necessarily satisfy the above-mentioned requirements. In other words, the two prescribed peaks of the DTG curve do not depend only on the composition of the compound.

Li_{1-x-δ}NiO₂ is used as an example in the following discussion of the mechanism involved in the release of oxygen from a composite oxide while in a charged state, during which a large amount of lithium is desorbed from the crystal structure, and the crystal structure is generally unstable. When such a composite oxide is used as the positive electrode active material and is heated in a charged state, the crystalline state undergoes phase transition from a layered rock-salt structure (R-3m) to a spinel structure (Fd-3m) or a rock-salt structure (Fm3m) within a prescribed temperature range, as shown by the following formulas (1) and (2). The temperature of the phase transition is within a temperature range of about 190 to 310° C. but will depend on the depth of charge. As shown by formulas (1) and (2), the transition is also thought to progress as oxygen gas is generated.

$$Formula ( 1 )$$

$${Li}_{1 - x - δ} {NiO}_{2} ( layered rock - salt structure R - 3 m ) \to \{ ( 1 - x - δ ) / ( 1 - δ ) \} {Li}_{1 - δ} {NiO}_{2} ( layered rock - salt structure 1 R - 3 m ) + \{ x / 3 ( 1 - δ ) \} {Ni}_{3} {O}_{4} ( spinel structure Fd - 3 m ) + \{ x / 3 ( 1 - δ ) \} {O}_{2} ↑$$

$$Formula ( 2 )$$

$$\{ ( 1 - x - δ ) / ( 1 - δ ) \} {Li}_{1 - δ} {NiO}_{2} ( layered rock - salt structure 1 R - 3 m ) \to ( 1 - x - δ ) {LiNiO}_{2} ( layered rock - salt structure 2 R - 3 m ) + \{ δ ( 1 - x - δ ) / ( 1 - δ ) \} NiO ( rock - salt structure 1 Fm3 m ) + \{ δ ( 1 - x - δ ) / 2 ( 1 - δ ) \} {O}_{2} ↑$$

$$\{ x / 3 ( 1 - δ ) \} {Ni}_{3} {O}_{4} ( spinel structure Fd - 3 m ) \to ( x / 3 ( 1 - δ ) \} NiO ( rock - salt structure 2 Fm 3 m ) + \{ x / 6 ( 1 - δ ) \} {O}_{2} ↑$$

The symbol “−” in R-3m originally appears above the 3, but is written here as shown above for the sake of convenience. Similarly, the symbol “−” in Fd-3m also originally appears above the 3, but is written here as shown above for the sake of convenience.

The inventors believed that this rapid generation of oxygen gas significantly affects the thermal stability of charged nonaqueous electrolyte secondary batteries.

When a charged nonaqueous electrolyte secondary battery overheats and the battery temperature rises, it is primarily the organic electrolyte in the nonaqueous electrolyte secondary battery that is oxidized (including combustion) by the oxygen gas generated via the reactions shown in formulas (1) and (2). As the reactions are exothermic, the temperature of the nonaqueous electrolyte secondary battery rises. As the rise in temperature results in further oxidation of the electrolyte, generating heat, the rise in temperature becomes uncontrollable, leading to thermal runaway.

The rise in temperature is proportional to the difference between the amount of heat that is generated per unit time in the nonaqueous electrolyte secondary battery and the amount of heat that is dissipated per unit time from the nonaqueous electrolyte secondary battery. Preventing the rapid concentration of the amount of heat and thermal flow that are brought about as shown in formulas (1) and (2) could curb the rise in temperature and prevent uncontrollable thermal runaway, resulting in better safety.

In view of the above, the inventors concluded that controlling the rate of oxygen release from the positive electrode active material is most important in order to curb uncontrollable thermal runaway. It can therefore be said, as noted in the present disclosure, that adjusting the release of oxygen from the composite oxide so that the oxygen is released over a plurality of temperature zones is an effective way to avoid rapid oxygen release in a narrow temperature zone.

Examples of composite oxides include, but are not particularly limited to, those represented by general formula Li[Liₓ(Ni_{1-y-z-w}Co_{y}Mn_{z}M_{w})₁₋ₓ]O₂ (where M is 1 or more elements other than Li, Ni, Co, Mn, O; and −0.1≤x≤0.15, 0<y≤0.4, 0≤z≤0.4, and 0≤w≤0.1).

The reason why the composite oxide serving as the positive electrode active material in the present disclosure exhibits multiple peaks is not necessarily known and is not bound to any particular theory, but the following has been considered by the inventors. In this type of composite oxide, most of the Ni in the positive electrode active material is oxidized to high-valent Ni⁴⁺ when in a high-SOC charged state, and is reduced to Ni²⁺ at temperatures in the range of 150° C. to 350° C. When that happens, the ionic radius of Ni²⁺ is about the same as that of Li⁺, and the Ni²⁺ thus migrates to the Li layer. The reduction of Ni⁴⁺ and the migration of Ni²⁺ into the Li layer occur almost simultaneously, and the inventors thought that, if the migration could be controlled, the reduction could also be controlled. In order to migrate to the Li layer, Ni²⁺ must move from the oxygen octahedral position of the metal layer in which the Ni²⁺ is present, through the vacant oxygen tetrahedral position in contact therewith, and then into the vacant oxygen octahedral position of the Li layer that is in contact therewith. Accordingly, if it were possible to increase the energy barrier for the Ni²⁺ to migrate to the vacant tetrahedral or octahedral position, reduction could take place at a higher temperature because of the extra energy needed for migration. When the height of the barrier required for Ni²⁺ migration is distributed in this manner, the temperature zone at which high-valence Ni is reduced can, as a result, be distributed. The amount of Ni that is reduced in one narrow temperature zone is thereby controlled to allow the amount of oxygen that is generated to also be controlled, thus making it possible to lower the DTG peak in one narrow temperature zone. It is thus apparent that the temperature at which oxygen is released can be distributed over a plurality of temperature zones, and that the DTG peak value can be lowered, as noted above, without sacrificing the basic performance of nonaqueous electrolyte secondary batteries (charge capacity and cycle characteristics) when the composite oxide used as the positive electrode active material is a composite oxide in which the above phenomena occur depending on, for example, the type of element M and the ratio of the element M with Li, Ni, Co, and Mn, as well as the crystallinity of the composite oxide and the conditions under which the composite oxide is synthesized.

Specifically, although it will depend on a combination of factors (such as the other elements contained in the composite oxide, as well as the crystallinity and the conditions of synthesis of the composite oxide), in cases where a composite oxide contains Co, it is believed that, at temperatures between about 230 and 270° C., Co³⁺ and Co⁴⁺ are reduced to Co²⁺, resulting in the formation of Co₃O₄ having a spinel structure, which remains in the oxygen tetrahedral position of the Li layer. The oxygen tetrahedral position serves as the path by which Ni²⁺ migrates to the oxygen octahedral position, and it appears that the occupation of this position by Co²⁺ would make it easier to control the migration of Ni²⁺ to the oxygen octahedral position. Thus, in cases such as this, there is a possibility that the temperature at which oxygen is released could be distributed over a plurality of temperature zones, and that the DTG peak value could be lowered, as noted above, without sacrificing the basic performance of nonaqueous electrolyte secondary batteries (charge capacity and cycle characteristics) when the composite oxide is used as the positive electrode active material.

In the general formula, the value of x is not particularly limited, provided that it is within the range of −0.10≤x≤0.15, but is, for example, preferably −0.095 or more, −0.09 or more, −0.085 or more, −0.08 or more, −0.075 or more, −0.07 or more, −0.065 or more, −0.06 or more, −0.055 or more, −0.05 or more, −0.045 or more, −0.04 or more, −0.035 or more, −0.03 or more, −0.025 or more, −0.02 or more, −0.015 or more, −0.01 or more, −0.0095 or more, −0.009 or more, −0.0085 or more, −0.008 or more, −0.0075 or more, −0.007 or more, −0.0065 or more, −0.006 or more, −0.0055 or more, −0.005 or more, −0.0045 or more, −0.004 or more, −0.0035 or more, −0.003 or more, −0.0025 or more, −0.002 or more, −0.0015 or more, −0.001 or more, 0 or more, 0.001 or more, 0.0015 or more, 0.002 or more, 0.0025 or more, 0.003 or more, 0.0035 or more, 0.004 or more, 0.0045 or more, 0.005 or more, 0.0055 or more, 0.006 or more, 0.0065 or more, 0.007 or more, 0.0075 or more, 0.008 or more, 0.0085 or more, 0.009 or more, 0.0095 or more, 0.01 or more, 0.015 or more, 0.02 or more, 0.025 or more, 0.03 or more, 0.035 or more, 0.04 or more, 0.045 or more, 0.05 or more, 0.055 or more, 0.06 or more, 0.065 or more, 0.07 or more, 0.075 or more, 0.08 or more, 0.085 or more, 0.09 or more, 0.095 or more, 0.1 or more, 0.102 or more, 0.105 or more, 0.107 or more, 0.11 or more, 0.112 or more, 0.115 or more, 0.117 or more, 0.12 or more, 0.122 or more, 0.125 or more, 0.127 or more, 0.13 or more, 0.132 or more, 0.135 or more, 0.137 or more, 0.14 or more, 0.142 or more, 0.145 or more, 0.147 or more, or 0.15 or more. On the other hand, the value of x is preferably 0.147 or less, 0.145 or less, 0.142 or less, 0.14 or less, 0.137 or less, 0.135 or less, 0.132 or less, 0.13 or less, 0.127 or less, 0.125 or less, 0.122 or less, 0.12 or less, 0.117 or less, 0.115 or less, 0.112 or less, 0.11 or less, 0.107 or less, 0.105 or less, 0.102 or less, 0.1 or less, 0.095 or less, 0.09 or less, 0.085 or less, 0.08 or less, 0.075 or less, 0.07 or less, 0.065 or less, 0.06 or less, 0.055 or less, 0.05 or less, 0.045 or less, 0.04 or less, 0.035 or less, 0.03 or less, 0.025 or less, 0.02 or less, 0.015 or less, 0.01 or less, 0.0095 or less, 0.009 or less, 0.0085 or less, 0.008 or less, 0.0075 or less, 0.007 or less, 0.0065 or less, 0.006 or less, 0.0055 or less, 0.005 or less, 0.0045 or less, 0.004 or less, 0.0035 or less, 0.003 or less, 0.0025 or less, 0.002 or less, 0.0015 or less, 0.001 or less, 0 or less, −0.001 or less, −0.0015 or less, −0.002 or less, −0.0025 or less, −0.003 or less, −0.0035 or less, −0.004 or less, −0.0045 or less, −0.005 or less, −0.0055 or less, −0.006 or less, −0.0065 or less, −0.007 or less, −0.0075 or less, −0.008 or less, −0.0085 or less, −0.009 or less, −0.0095 or less, −0.01 or less, −0.015 or less, −0.02 or less, −0.025 or less, −0.03 or less, −0.035 or less, −0.04 or less, −0.045 or less, −0.05 or less, −0.055 or less, −0.06 or less, −0.065 or less, −0.07 or less, −0.075 or less, −0.08 or less, −0.085 or less, −0.09 or less, or −0.095 or less. Ensuring that the value of x is within the prescribed range means that the Li content will be within the prescribed range. Ensuring that the value of x is at least the prescribed minimum value can increase the Li content, reduce Li vacancies, curb first-order reduction of Ni occurring between about 200 to 250° C., and increase second-order reduction occurring between about 260° C. and 320° C. As a result, the peak top on the low temperature side of the derivative thermogravimetric curve will tend to decrease, whereas the peak top on the high temperature side will tend to increase. Ensuring that the value of x is no greater than the prescribed maximum value can keep Li vacancies at a constant level and can curb loss of charging capacity.

In the general formula, the value of 1-y-z-w is not particularly limited, provided that it is a combination within the applicable range for y, z, and w, but is, for example, preferably 0.6 or more, 0.605 or more, 0.61 or more, 0.615 or more, 0.62 or more, 0.625 or more, 0.63 or more, 0.635 or more, 0.64 or more, 0.645 or more, 0.65 or more, 0.655 or more, 0.66 or more, 0.665 or more, 0.67 or more, 0.675 or more, 0.68 or more, 0.685 or more, 0.69 or more, 0.695 or more, 0.70 or more, 0.705 or more, 0.71 or more, 0.715 or more, 0.72 or more, 0.725 or more, 0.73 or more, 0.735 or more, 0.74 or more, 0.745 or more, 0.75 or more, 0.755 or more, 0.76 or more, 0.765 or more, 0.77 or more, 0.775 or more, 0.78 or more, 0.785 or more, 0.79 or more, or 0.795 or more. On the other hand, the value of 1-y-z-w may be 1 or less, 0.995 or less, 0.99 or less, 0.985 or less, 0.98 or less, 0.975 or less, 0.97 or less, 0.965 or less, 0.96 or less, 0.955 or less, 0.95 or less, 0.945 or less, 0.94 or less, 0.935 or less, 0.93 or less, 0.925 or less, 0.92 or less, 0.915 or less, 0.91 or less, 0.905 or less, 0.90 or less, 0.895 or less, 0.89 or less, 0.885 or less, 0.88 or less, 0.875 or less, 0.87 or less, 0.865 or less, 0.86 or less, 0.855 or less, 0.85 or less, 0.845 or less, or 0.84 or less. Ensuring that the value of 1-y-z-w is within the prescribed range means that the Ni content will be within the prescribed range. Ensuring that the value of 1-y-z-w is at least the prescribed minimum value can ensure greater Ni migration in the composite oxide. On the other hand, ensuring that the value of 1-y-z-w is no greater than the prescribed maximum value will make it possible to leave room to include functional elements that can inhibit some Ni migration, although it will depend on the balance with other elements, etc.

In the general formula, the value of y is not particularly limited, provided that it is within the range of 0≤y≤0.4, but is, for example, preferably more than 0, 0.001 or more, 0.0015 or more, 0.002 or more, 0.0025 or more, 0.003 or more, 0.0035 or more, 0.004 or more, 0.0045 or more, 0.005 or more, 0.0055 or more, 0.006 or more, 0.0065 or more, 0.007 or more, 0.0075 or more, 0.008 or more, 0.0085 or more, 0.009 or more, 0.0095 or more, 0.01 or more, 0.015 or more, 0.02 or more, 0.025 or more, 0.03 or more, 0.035 or more, 0.04 or more, 0.045 or more, 0.05 or more, 0.055 or more, 0.06 or more, 0.065 or more, 0.07 or more, 0.075 or more, 0.08 or more, 0.085 or more, 0.09 or more, 0.095 or more, 0.1 or more, 0.102 or more, 0.105 or more, 0.107 or more, 0.11 or more, 0.112 or more, 0.115 or more, 0.117 or more, 0.12 or more, 0.122 or more, 0.125 or more, 0.127 or more, 0.13 or more, 0.132 or more, 0.135 or more, 0.137 or more, 0.14 or more, 0.142 or more, 0.145 or more, 0.147 or more, 0.15 or more, 0.152 or more, 0.155 or more, 0.157 or more, 0.16 or more, 0.162 or more, 0.165 or more, 0.167 or more, 0.17 or more, 0.172 or more, 0.175 or more, 0.177 or more, 0.18 or more, 0.182 or more, 0.185 or more, 0.187 or more, 0.19 or more, 0.192 or more, 0.195 or more, 0.197 or more, 0.2 or more, 0.202 or more, 0.205 or more, 0.207 or more, 0.21 or more, 0.212 or more, 0.215 or more, 0.217 or more, 0.22 or more, 0.222 or more, 0.225 or more, 0.227 or more, 0.23 or more, 0.232 or more, 0.235 or more, 0.237 or more, 0.24 or more, 0.242 or more, 0.245 or more, 0.247 or more, 0.25 or more, 0.252 or more, 0.255 or more, 0.257 or more, 0.26 or more, 0.262 or more, 0.265 or more, 0.267 or more, 0.27 or more, 0.272 or more, 0.275 or more, 0.277 or more, 0.28 or more, 0.282 or more, 0.285 or more, 0.287 or more, 0.29 or more, 0.292 or more, 0.295 or more, 0.297 or more, 0.3 or more, 0.302 or more, 0.305 or more, 0.307 or more, 0.31 or more, 0.312 or more, 0.315 or more, 0.317 or more, 0.32 or more, 0.322 or more, 0.325 or more, 0.327 or more, 0.33 or more, 0.332 or more, 0.335 or more, 0.337 or more, 0.34 or more, 0.342 or more, 0.345 or more, 0.347 or more, 0.35 or more, 0.352 or more, 0.355 or more, 0.357 or more, 0.36 or more, 0.362 or more, 0.365 or more, 0.367 or more, 0.37 or more, 0.372 or more, 0.375 or more, 0.377 or more, 0.38 or more, 0.382 or more, 0.385 or more, 0.387 or more, 0.39 or more, 0.392 or more, 0.395 or more, or 0.397 or more. On the other hand, the value of y is preferably 0.397 or less, 0.395 or less, 0.392 or less, 0.39 or less, 0.387 or less, 0.385 or less, 0.382 or less, 0.38 or less, 0.377 or less, 0.375 or less, 0.372 or less, 0.367 or less, 0.365 or less, 0.362 or less, 0.36 or less, 0.357 or less, 0.355 or less, 0.352 or less, 0.35 or less, 0.347 or less, 0.345 or less, 0.342 or less, 0.34 or less, 0.337 or less, 0.335 or less, 0.332 or less, 0.33 or less, 0.327 or less, 0.325 or less, 0.322 or less, 0.32 or less, 0.317 or less, 0.315 or less, 0.312 or less, 0.31 or less, 0.307 or less, 0.305 or less, 0.302 or less, 0.3 or less, 0.297 or less, 0.295 or less, 0.292 or less, 0.29 or less, 0.287 or less, 0.285 or less, 0.282 or less, 0.28 or less, 0.277 or less, 0.275 or less, 0.272 or less, 0.27 or less, 0.267 or less, 0.265 or less, 0.26 or less, 0.257 or less, 0.255 or less, 0.252 or less, 0.25 or less, 0.247 or less, 0.245 or less, 0.242 or less, 0.24 or less, 0.237 or less, 0.235 or less, 0.232 or less, 0.23 or less, 0.227 or less, 0.225 or less, 0.222 or less, 0.22 or less, 0.217 or less, 0.215 or less, 0.212 or less, 0.21 or less, 0.207 or less, 0.205 or less, 0.202 or less, 0.2 or less, 0.197 or less, 0.195 or less, 0.192 or less, 0.19 or less, 0.187 or less, 0.185 or less, 0.182 or less, 0.18 or less, 0.177 or less, 0.175 or less, 0.172 or less, 0.17 or less, 0.167 or less, 0.165 or less, 0.162 or less, 0.16 or less, 0.155 or less, 0.152 or less, 0.15 or less, 0.147 or less, 0.145 or less, 0.142 or less, 0.14 or less, 0.137 or less, 0.135 or less, 0.132 or less, 0.13 or less, 0.127 or less, 0.125 or less, 0.122 or less, 0.12 or less, 0.117 or less, 0.115 or less, 0.112 or less, 0.11 or less, 0.107 or less, 0.105 or less, 0.102 or less, 0.1 or less, 0.095 or less, 0.09 or less, 0.085 or less, 0.08 or less, 0.075 or less, 0.07 or less, 0.065 or less, 0.06 or less, 0.055 or less, 0.05 or less, 0.045 or less, 0.04 or less, 0.035 or less, 0.03 or less, 0.025 or less, 0.02 or less, 0.015 or less, 0.01 or less, 0.0095 or less, 0.009 or less, 0.0085 or less, 0.008 or less, 0.0075 or less, 0.007 or less, 0.0065 or less, 0.006 or less, 0.0055 or less, 0.005 or less, 0.0045 or less, 0.004 or less, 0.0035 or less, 0.003 or less, 0.0025 or less, 0.002 or less, 0.0015 or less, or 0.001 or less. Ensuring that the value of y is within the prescribed range means that the Co content will be within the prescribed range. Ensuring that the value of y is at least the prescribed minimum value can increase the Co, which can increase the level of second-order reduction of Ni⁴⁺. On the other hand, even if the value of y is at least the prescribed minimum value, the value should be no greater than the prescribed maximum value in order to cap the increase in second-order reduction.

In the general formula, the value of z is not particularly limited, provided that it is within the range of 0≤z≤0.4, but is, for example, preferably 0.001 or more, 0.0015 or more, 0.002 or more, 0.0025 or more, 0.003 or more, 0.0035 or more, 0.004 or more, 0.0045 or more, 0.005 or more, 0.0055 or more, 0.006 or more, 0.0065 or more, 0.007 or more, 0.0075 or more, 0.008 or more, 0.0085 or more, 0.009 or more, 0.0095 or more, 0.01 or more, 0.015 or more, 0.02 or more, 0.025 or more, 0.03 or more, 0.035 or more, 0.04 or more, 0.045 or more, 0.05 or more, 0.055 or more, 0.06 or more, 0.065 or more, 0.07 or more, 0.075 or more, 0.08 or more, 0.085 or more, 0.09 or more, 0.095 or more, 0.1 or more, 0.102 or more, 0.105 or more, 0.107 or more, 0.11 or more, 0.112 or more, 0.115 or more, 0.117 or more, 0.12 or more, 0.122 or more, 0.125 or more, 0.127 or more, 0.13 or more, 0.132 or more, 0.135 or more, 0.137 or more, 0.14 or more, 0.142 or more, 0.145 or more, 0.147 or more, 0.15 or more, 0.152 or more, 0.155 or more, 0.157 or more, 0.16 or more, 0.162 or more, 0.165 or more, 0.167 or more, 0.17 or more, 0.172 or more, 0.175 or more, 0.177 or more, 0.18 or more, 0.182 or more, 0.185 or more, 0.187 or more, 0.19 or more, 0.192 or more, 0.195 or more, 0.197 or more, 0.2 or more, 0.202 or more, 0.205 or more, 0.207 or more, 0.21 or more, 0.212 or more, 0.215 or more, 0.217 or more, 0.22 or more, 0.222 or more, 0.225 or more, 0.227 or more, 0.23 or more, 0.232 or more, 0.235 or more, 0.237 or more, 0.24 or more, 0.242 or more, 0.245 or more, 0.247 or more, 0.25 or more, 0.252 or more, 0.255 or more, 0.257 or more, 0.26 or more, 0.262 or more, 0.265 or more, 0.267 or more, 0.27 or more, 0.272 or more, 0.275 or more, 0.277 or more, 0.28 or more, 0.282 or more, 0.285 or more, 0.287 or more, 0.29 or more, 0.292 or more, 0.295 or more, 0.297 or more, 0.3 or more, 0.302 or more, 0.305 or more, 0.307 or more, 0.31 or more, 0.312 or more, 0.315 or more, 0.317 or more, 0.32 or more, 0.322 or more, 0.325 or more, 0.327 or more, 0.33 or more, 0.332 or more, 0.335 or more, 0.337 or more, 0.34 or more, 0.342 or more, 0.345 or more, 0.347 or more, 0.35 or more, 0.352 or more, 0.355 or more, 0.357 or more, 0.36 or more, 0.362 or more, 0.365 or more, 0.367 or more, 0.37 or more, 0.372 or more, 0.375 or more, 0.377 or more, 0.38 or more, 0.382 or more, 0.385 or more, 0.387 or more, 0.39 or more, 0.392 or more, 0.395 or more, or 0.397 or more. On the other hand, the value of z is preferably 0.397 or less, 0.395 or less, 0.392 or less, 0.39 or less, 0.387 or less, 0.385 or less, 0.382 or less, 0.38 or less, 0.377 or less, 0.375 or less, 0.372 or less, 0.367 or less, 0.365 or less, 0.362 or less, 0.36 or less, 0.357 or less, 0.355 or less, 0.352 or less, 0.35 or less, 0.347 or less, 0.345 or less, 0.342 or less, 0.34 or less, 0.337 or less, 0.335 or less, 0.332 or less, 0.33 or less, 0.327 or less, 0.325 or less, 0.322 or less, 0.32 or less, 0.317 or less, 0.315 or less, 0.312 or less, 0.31 or less, 0.307 or less, 0.305 or less, 0.302 or less, 0.3 or less, 0.297 or less, 0.295 or less, 0.292 or less, 0.29 or less, 0.287 or less, 0.285 or less, 0.282 or less, 0.28 or less, 0.277 or less, 0.275 or less, 0.272 or less, 0.27 or less, 0.267 or less, 0.265 or less, 0.26 or less, 0.257 or less, 0.255 or less, 0.252 or less, 0.25 or less, 0.247 or less, 0.245 or less, 0.242 or less, 0.24 or less, 0.237 or less, 0.235 or less, 0.232 or less, 0.23 or less, 0.227 or less, 0.225 or less, 0.222 or less, 0.22 or less, 0.217 or less, 0.215 or less, 0.212 or less, 0.21 or less, 0.207 or less, 0.205 or less, 0.202 or less, 0.2 or less, 0.197 or less, 0.195 or less, 0.192 or less, 0.19 or less, 0.187 or less, 0.185 or less, 0.182 or less, 0.18 or less, 0.177 or less, 0.175 or less, 0.172 or less, 0.17 or less, 0.167 or less, 0.165 or less, 0.162 or less, 0.16 or less, 0.155 or less, 0.152 or less, 0.15 or less, 0.147 or less, 0.145 or less, 0.142 or less, 0.14 or less, 0.137 or less, 0.135 or less, 0.132 or less, 0.13 or less, 0.127 or less, 0.125 or less, 0.122 or less, 0.12 or less, 0.117 or less, 0.115 or less, 0.112 or less, 0.11 or less, 0.107 or less, 0.105 or less, 0.102 or less, 0.1 or less, 0.095 or less, 0.09 or less, 0.085 or less, 0.08 or less, 0.075 or less, 0.07 or less, 0.065 or less, 0.06 or less, 0.055 or less, 0.05 or less, 0.045 or less, 0.04 or less, 0.035 or less, 0.03 or less, 0.025 or less, 0.02 or less, 0.015 or less, 0.01 or less, 0.0095 or less, 0.009 or less, 0.0085 or less, 0.008 or less, 0.0075 or less, 0.007 or less, 0.0065 or less, 0.006 or less, 0.0055 or less, 0.005 or less, 0.0045 or less, 0.004 or less, 0.0035 or less, 0.003 or less, 0.0025 or less, 0.002 or less, 0.0015 or less, or 0.001 or less. Ensuring that the value of z is within the prescribed range means that the Mn content will be within the prescribed range. Ensuring the that value of z is at least the prescribed minimum value can facilitate the formation of Li₂MnO₃, increase Li vacancies, and promote the migration of Ni and Co into the Li layer. Ensuring the the value of z is no greater than the prescribed maximum value will allow more Li₂MnO₃ to be formed, thereby curbing loss of charging capacity caused by an excessive increase in Li vacancies.

In the general formula, the value of w is not particularly limited, provided that it is within the range of 0≤w≤0.1, but is, for example, preferably 0.001 or more, 0.0012 or more, 0.0015 or more, 0.0017 or more, 0.002 or more, 0.0022 or more, 0.0025 or more, 0.0027 or more, 0.003 or more, 0.0032 or more, 0.0035 or more, 0.0037 or more, 0.004 or more, 0.0042 or more, 0.0045 or more, 0.0047 or more, 0.005 or more, 0.0052 or more, 0.0055 or more, 0.0057 or more, 0.006 or more, 0.0062 or more, 0.0065 or more, 0.0067 or more, 0.007 or more, 0.0072 or more, 0.0075 or more, 0.0077 or more, 0.008 or more, 0.0082 or more, 0.0085 or more, 0.0087 or more, 0.009 or more, 0.0092 or more, 0.0095 or more, 0.0097 or more, 0.01 or more, 0.012 or more, 0.015 or more, 0.017 or more, 0.02 or more, 0.022 or more, 0.025 or more, 0.027 or more, 0.03 or more, 0.032 or more, 0.035 or more, 0.037 or more, 0.04 or more, 0.042 or more, 0.045 or more, 0.047 or more, 0.05 or more, 0.052 or more, 0.055 or more, 0.057 or more, 0.06 or more, 0.062 or more, 0.065 or more, 0.067 or more, 0.07 or more, 0.072 or more, 0.075 or more, 0.077 or more, 0.08 or more, 0.082 or more, 0.085 or more, 0.087 or more, 0.09 or more, 0.092 or more, 0.095 or more, or 0.097 or more. On the other hand, the value of w is preferably 0.097 or less, 0.095 or less, 0.092 or less, 0.09 or less, 0.087 or less, 0.085 or less, 0.082 or less, 0.08 or less, 0.077 or less, 0.075 or less, 0.072 or less, 0.07 or less, 0.067 or less, 0.065 or less, 0.062 or less, 0.06 or less, 0.057 or less, 0.055 or less, 0.052 or less, 0.05 or less, 0.047 or less, 0.045 or less, 0.042 or less, 0.04 or less, 0.037 or less, 0.035 or less, 0.032 or less, 0.03 or less, 0.027 or less, 0.025 or less, 0.022 or less, 0.02 or less, 0.017 or less, 0.015 or less, 0.012 or less, 0.01 or less, 0.0097 or less, 0.0095 or less, 0.0092 or less, 0.009 or less, 0.0087 or less, 0.0085 or less, 0.0082 or less, 0.008 or less, 0.0077 or less, 0.0075 or less, 0.0072 or less, 0.007 or less, 0.0067 or less, 0.0065 or less, 0.0062 or less, 0.006 or less, 0.0057 or less, 0.0055 or less, 0.0052 or less, 0.005 or less, 0.0047 or less, 0.0045 or less, 0.0042 or less, 0.004 or less, 0.0037 or less, 0.0035 or less, 0.0032 or less, 0.003 or less, 0.0027 or less, 0.0025 or less, 0.0022 or less, 0.002 or less, 0.0017 or less, 0.0015 or less, 0.0012 or less, or 0.001 or less. Ensuring that the value of w is within the prescribed range means that the content of the element M will be within the prescribed range. Ensuring that the value of w is at least the prescribed minimum value will ensure that the addition of the element M produces the intended effect. Ensuring that the value of w is no greater than the maximum value will ensure the prescribed content of Ni, Co, and Mn, thus preserving the battery performance, including a high charging capacity, that is afforded by those elements.

In the formula, the element M is not particularly limited, provided that it is one or more elements other than Li, Ni, Co, Mn and O, where examples that can be used include Al, Ti, Mg, Zn, Nb, W, Mo, Sb, V, Cr, Ca, Fe, Ga, Sr, Y, Ru, In, Sn, Ta, Bi, Zr, and B. The type of element M should be selected depending on the purpose for which it is being added. When a plurality of elements are used as the element M, the value of w represents the total amount of the plurality of elements.

Of these, the use of Al as the element M is preferred When Al is used as the element M, the Al will be fixed at specific sites to form a stable structure. As a result, it will be more difficult for Li⁺ near the Al to migrate, Li⁺ and Ni²⁺ cation mixing will be controlled, and a higher temperature will be required for oxygen to be released in some parts of the composite oxide. As a result, when the composite oxide includes Al, the peak attributed to oxygen release that occurs between about 200 and 250° C. in the DTG curve will be broader and thermal runaway will be easier to control than when Li₂MnO₃ is not included.

The value of w (w_{Al} represents content of Al only) is not particularly limited, but is preferably, for example, 0 or more, 0.001 or more, 0.0012 or more, 0.0015 or more, 0.0017 or more, 0.002 or more, 0.0022 or more, 0.0025 or more, 0.0027 or more, 0.003 or more, 0.0032 or more, 0.0035 or more, 0.0037 or more, 0.004 or more, 0.0042 or more, 0.0045 or more, 0.0047 or more, 0.005 or more, 0.0052 or more, 0.0055 or more, 0.0057 or more, 0.006 or more, 0.0062 or more, 0.0065 or more, 0.0067 or more, 0.007 or more, 0.0072 or more, 0.0075 or more, 0.0077 or more, 0.008 or more, 0.0082 or more, 0.0085 or more, 0.0087 or more, 0.009 or more, 0.0092 or more, 0.0095 or more, 0.0097 or more, 0.01 or more, 0.012 or more, 0.015 or more, 0.017 or more, 0.02 or more, 0.022 or more, 0.025 or more, 0.027 or more, 0.03 or more, 0.032 or more, 0.035 or more, 0.037 or more, 0.04 or more, 0.042 or more, 0.045 or more, 0.047 or more, 0.05 or more, 0.052 or more, 0.055 or more, 0.057 or more, 0.06 or more, 0.062 or more, 0.065 or more, 0.067 or more, 0.07 or more, 0.072 or more, 0.075 or more, 0.077 or more, 0.08 or more, 0.082 or more, 0.085 or more, 0.087 or more, 0.09 or more, 0.092 or more, 0.095 or more, or 0.097 or more. On the other hand, the value of w is preferably 0.1 or less, 0.097 or less, 0.095 or less, 0.092 or less, 0.09 or less, 0.087 or less, 0.085 or less, 0.082 or less, 0.08 or less, 0.077 or less, 0.075 or less, 0.072 or less, 0.07 or less, 0.067 or less, 0.065 or less, 0.062 or less, 0.06 or less, 0.057 or less, 0.055 or less, 0.052 or less, 0.05 or less, 0.047 or less, 0.045 or less, 0.042 or less, 0.04 or less, 0.037 or less, 0.035 or less, 0.032 or less, 0.03 or less, 0.027 or less, 0.025 or less, 0.022 or less, 0.02 or less, 0.017 or less, 0.015 or less, 0.012 or less, 0.01 or less, 0.0097 or less, 0.0095 or less, 0.0092 or less, 0.009 or less, 0.0087 or less, 0.0085 or less, 0.0082 or less, 0.008 or less, 0.0077 or less, 0.0075 or less, 0.0072 or less, 0.007 or less, 0.0067 or less, 0.0065 or less, 0.0062 or less, 0.006 or less, 0.0057 or less, 0.0055 or less, 0.0052 or less, 0.005 or less, 0.0047 or less, 0.0045 or less, 0.0042 or less, 0.004 or less, 0.0037 or less, 0.0035 or less, 0.0032 or less, 0.003 or less, 0.0027 or less, 0.0025 or less, 0.0022 or less, 0.002 or less, 0.0017 or less, 0.0015 or less, 0.0012 or less, or 0.001 or less. Ensuring that the value of w_{Al} is within the prescribed range means that the Al content will be within the prescribed range. Ensuring that the value of w_{Al} is at least the prescribed minimum value will ensure that, as a result of the addition of the Al, the peak attributed to oxygen release that occurs between about 200 and 250° C. in the DTG curve will become broader and that thermal runaway will be easier to control. Ensuring that the value of w_{Al} is no greater than the maximum value will ensure the prescribed content of Ni, Co, and Mn, thus preserving the battery performance, including a high charging capacity, that is afforded by those elements.

In the general formula, the value of z+w is not particularly limited, provided that it is within the range of 0≤z≤0.4 and 0≤w≤0.1, but is, for example, preferably more than 0, 0.001 or more, 0.0015 or more, 0.002 or more, 0.0025 or more, 0.003 or more, 0.0035 or more, 0.004 or more, 0.0045 or more, 0.005 or more, 0.0055 or more, 0.006 or more, 0.0065 or more, 0.007 or more, 0.0075 or more, 0.008 or more, 0.0085 or more, 0.009 or more, 0.0095 or more, 0.01 or more, 0.015 or more, 0.02 or more, 0.025 or more, 0.03 or more, 0.035 or more, 0.04 or more, 0.045 or more, 0.05 or more, 0.055 or more, 0.06 or more, 0.065 or more, 0.07 or more, 0.075 or more, 0.08 or more, 0.085 or more, 0.09 or more, 0.095 or more, 0.1 or more, 0.102 or more, 0.105 or more, 0.107 or more, 0.11 or more, 0.112 or more, 0.115 or more, 0.117 or more, 0.12 or more, 0.122 or more, 0.125 or more, 0.127 or more, 0.13 or more, 0.132 or more, 0.135 or more, 0.137 or more, 0.14 or more, 0.142 or more, 0.145 or more, 0.147 or more, 0.15 or more, 0.152 or more, 0.155 or more, 0.157 or more, 0.16 or more, 0.162 or more, 0.165 or more, 0.167 or more, 0.17 or more, 0.172 or more, 0.175 or more, 0.177 or more, 0.18 or more, 0.182 or more, 0.185 or more, 0.187 or more, 0.19 or more, 0.192 or more, 0.195 or more, 0.197 or more, 0.2 or more, 0.202 or more, 0.205 or more, 0.207 or more, 0.21 or more, 0.212 or more, 0.215 or more, 0.217 or more, 0.22 or more, 0.222 or more, 0.225 or more, 0.227 or more, 0.23 or more, 0.232 or more, 0.235 or more, 0.237 or more, 0.24 or more, 0.242 or more, 0.245 or more, 0.247 or more, 0.25 or more, 0.252 or more, 0.255 or more, 0.257 or more, 0.26 or more, 0.262 or more, 0.265 or more, 0.267 or more, 0.27 or more, 0.272 or more, 0.275 or more, 0.277 or more, 0.28 or more, 0.282 or more, 0.285 or more, 0.287 or more, 0.29 or more, 0.292 or more, 0.295 or more, 0.297 or more, 0.3 or more, 0.302 or more, 0.305 or more, 0.307 or more, 0.31 or more, 0.312 or more, 0.315 or more, 0.317 or more, 0.32 or more, 0.322 or more, 0.325 or more, 0.327 or more, 0.33 or more, 0.332 or more, 0.335 or more, 0.337 or more, 0.34 or more, 0.342 or more, 0.345 or more, 0.347 or more, 0.35 or more, 0.352 or more, 0.355 or more, 0.357 or more, 0.36 or more, 0.362 or more, 0.365 or more, 0.367 or more, 0.37 or more, 0.372 or more, 0.375 or more, 0.377 or more, 0.38 or more, 0.382 or more, 0.385 or more, 0.387 or more, 0.39 or more, 0.392 or more, 0.395 or more, 0.397 or more, 0.4 or more, 0.402 or more, 0.405 or more, 0.407 or more, 0.41 or more, 0.412 or more, 0.415 or more, 0.417 or more, 0.42 or more, 0.422 or more, 0.425 or more, 0.427 or more, 0.43 or more, 0.432 or more, 0.435 or more, 0.437 or more, 0.44 or more, 0.442 or more, 0.445 or more, 0.447 or more, 0.45 or more, 0.452 or more, 0.455 or more, 0.457 or more, 0.46 or more, 0.462 or more, 0.465 or more, 0.467 or more, 0.47 or more, 0.472 or more, 0.475 or more, 0.477 or more, 0.48 or more, 0.482 or more, 0.485 or more, 0.487 or more, 0.49 or more, 0.492 or more, 0.495 or more, or 0.497 or more. On the other hand, the value of z+w is preferably 0.5 or less, 0.497 or less, 0.495 or less, 0.492 or less, 0.49 or less, 0.487 or less, 0.485 or less, 0.482 or less, 0.48 or less, 0.477 or less, 0.475 or less, 0.472 or less, 0.467 or less, 0.465 or less, 0.462 or less, 0.46 or less, 0.457 or less, 0.455 or less, 0.452 or less, 0.45 or less, 0.447 or less, 0.445 or less, 0.442 or less, 0.44 or less, 0.437 or less, 0.435 or less, 0.432 or less, 0.43 or less, 0.427 or less, 0.425 or less, 0.422 or less, 0.42 or less, 0.417 or less, 0.415 or less, 0.412 or less, 0.41 or less, 0.407 or less, 0.405 or less, 0.402 or less, 0.4 or less, 0.397 or less, 0.395 or less, 0.392 or less, 0.39 or less, 0.387 or less, 0.385 or less, 0.382 or less, 0.38 or less, 0.377 or less, 0.375 or less, 0.372 or less, 0.367 or less, 0.365 or less, 0.362 or less, 0.36 or less, 0.357 or less, 0.355 or less, 0.352 or less, 0.35 or less, 0.347 or less, 0.345 or less, 0.342 or less, 0.34 or less, 0.337 or less, 0.335 or less, 0.332 or less, 0.33 or less, 0.327 or less, 0.325 or less, 0.322 or less, 0.32 or less, 0.317 or less, 0.315 or less, 0.312 or less, 0.31 or less, 0.307 or less, 0.305 or less, 0.302 or less, 0.3 or less, 0.297 or less, 0.295 or less, 0.292 or less, 0.29 or less, 0.287 or less, 0.285 or less, 0.282 or less, 0.28 or less, 0.277 or less, 0.275 or less, 0.272 or less, 0.27 or less, 0.267 or less, 0.265 or less, 0.26 or less, 0.257 or less, 0.255 or less, 0.252 or less, 0.25 or less, 0.247 or less, 0.245 or less, 0.242 or less, 0.24 or less, 0.237 or less, 0.235 or less, 0.232 or less, 0.23 or less, 0.227 or less, 0.225 or less, 0.222 or less, 0.22 or less, 0.217 or less, 0.215 or less, 0.212 or less, 0.21 or less, 0.207 or less, 0.205 or less, 0.202 or less, 0.2 or less, 0.197 or less, 0.195 or less, 0.192 or less, 0.19 or less, 0.187 or less, 0.185 or less, 0.182 or less, 0.18 or less, 0.177 or less, 0.175 or less, 0.172 or less, 0.17 or less, 0.167 or less, 0.165 or less, 0.162 or less, 0.16 or less, 0.155 or less, 0.152 or less, 0.15 or less, 0.147 or less, 0.145 or less, 0.142 or less, 0.14 or less, 0.137 or less, 0.135 or less, 0.132 or less, 0.13 or less, 0.127 or less, 0.125 or less, 0.122 or less, 0.12 or less, 0.117 or less, 0.115 or less, 0.112 or less, 0.11 or less, 0.107 or less, 0.105 or less, 0.102 or less, 0.1 or less, 0.095 or less, 0.09 or less, 0.085 or less, 0.08 or less, 0.075 or less, 0.07 or less, 0.065 or less, 0.06 or less, 0.055 or less, 0.05 or less, 0.045 or less, 0.04 or less, 0.035 or less, 0.03 or less, 0.025 or less, 0.02 or less, 0.015 or less, 0.01 or less, 0.0095 or less, 0.009 or less, 0.0085 or less, 0.008 or less, 0.0075 or less, 0.007 or less, 0.0065 or less, 0.006 or less, 0.0055 or less, 0.005 or less, 0.0045 or less, 0.004 or less, 0.0035 or less, 0.003 or less, 0.0025 or less, 0.002 or less, 0.0015 or less, or 0.001 or less.

The configuration of the composite oxide is not particularly limited, and may be, for example, in the form of particles. When a composite oxide in the form of particles is used, the particles may be in the form of secondary particles formed by the aggregation of primary particles, or may be in the form of primary particles as such, or may be in the form of a mixture of secondary particles and primary particles. If the primary particles have the same particle size distribution, the temperature at which oxygen is released from the composite oxide will not change substantially, no matter what the configuration may be.

The average particle size of the primary particles of the composite oxide is not particularly limited, but is preferably, for example, 80 nm or more, 100 nm or more, 120 nm or more, 150 nm or more, 170 nm or more, 200 nm or more, 250 nm or more, 300 nm or more, 350 nm or more, 400 nm or more, or 450 nm or more. Ensuring that the average particle size of the composite oxide is at least the minimum prescribed value will make it possible to increase the temperature at which oxygen is released. On the other hand, the average particle size of the primary particles is preferably 15 μm or less, 14.5 μm or less, 14 μm or less, 13.5 μm or less, 13 μm or less, 12.5 μm or less, 12 μm or less, 11.5 μm or less, 11 μm or less, 10.5 μm or less, 10 μm or less, 9.5 μm or less, 9 μm or less, 8.5 μm or less, 8 μm or less, 7.5 μm or less, 7 μm or less, 6.5 μm or less, 6 μm or less, 5.5 μm or less, 5 μm or less, or 4.5 μm or less. Ensuring that the average particle size of the primary particles is no greater than the prescribed maximum value will make it possible to increase the energy density and to control cycle-associated particle destruction or loss of rate characteristics. The average particle size of the primary particles of the composite oxide is calculated via observation of electron micrographs taken using a field emission scanning electron microscope (JSM-7100F: manufactured by JEOL Ltd.) at an acceleration voltage of 10 kV and at 3000 to 20000× magnification. Specifically, a field of view in which 100 or more primary particles (confirmed particle outline) are visible is randomly selected, and electron micrographs of all particles (confirmed particle outline) among the particles in the field of view are obtained, with the magnification changed as needed within the range noted above. The electron micrographs are then used to calculate the equivalent spherical diameter via image processing software (such as ImageJ) to determine the particle size of the primary particles.

The average particle size (D50) of the primary particles of the composite oxide is also not particularly limited, but is preferably, for example, 80 nm or more, 100 nm or more, 120 nm or more, 150 nm or more, 170 nm or more, 200 nm or more, 250 nm or more, 300 nm or more, 350 nm or more, 400 nm or more, or 450 nm or more. Ensuring that the D50 is at least the prescribed minimum value will make it possible to increase the temperature at which oxygen is released and to also increase the electrode density. Meanwhile, the D50 is preferably 25 μm or less, 24.5 μm or less, 24 μm or less, 23.5 μm or less, 23 μm or less, 22.5 μm or less, 22 μm or less, 21.5 μm or less, 21 μm or less, 20.5 μm or less, 20 μm or less, 19.5 μm or less, 19 μm or less, 18.5 μm or less, 18 μm or less, 17.5 μm or less, 17 μm or less, 16.5 μm or less, 16 μm or less, 15.5 μm or less, 15 μm or less, 14.5 μm or less, 14 μm or less, 13.5 μm or less, 13 μm or less, 12.5 μm or less, 12 μm or less, 11.5 μm or less, 11 μm or less, 10.5 μm or less, 10 μm or less, 9.5 μm or less, 9 μm or less, 8.5 μm or less, 8 μm or less, 7.5 μm or less, 7 μm or less, 6.5 μm or less, 6 μm or less, 5.5 μm or less, 5 μm or less, or 4.5 μm or less. Ensuring that the D50 is no greater than the prescribed maximum value will make it possible to increase the energy density of nonaqueous electrolyte secondary batteries in which the composite oxide is used, and also to control cycle-associated particle destruction or loss of rate characteristics. The D50 is determined on a volume basis by a wet laser method using a laser type particle size distribution analyzer (Microtrac HRA, manufactured by Nikkiso Co., Ltd.).

The DTG curve of the composite oxide in the present disclosure is obtained when a sample of the composite oxide, that has been charged by the charging method shown below, is heated from 50° C. to 600° C. at a rate of 5° C./min.

The derivative thermogravimetric curve obtained in this manner is fitted using a log-normal distribution function to separate the peaks and to thereby calculate the peak top temperature and weight loss rate (oxygen release rate) of each peak.

Specifically, a thermal analysis weight curve is obtained by the method described below using a thermogravimetric-differential thermal analyzer (TG-DTA) unit (DTG-60H, manufactured by Shimadzu Corporation); the first peak and second peak are then analyzed.

### <Sample Preparation>

A 2032 type coin cell having a lithium counter electrode is produced in accordance with the method described below, and is charged at a constant current of 0.3 C to 4.30 V at a temperature of 25° C. and then charged as at constant voltage to a current value of 0.05 C. After a 20-minute break following the completion of charging, the coin cell is discharged at a constant current of 0.3 C to 2.50 V, and is then discharged at a constant current of 0.1 C, followed by a 20-minute break. The charging and discharging are repeated twice. The coin cell is then charged at a constant current of 0.3 C to 4.30 V, and then charged at a constant voltage to a current value of 0.05 C, followed by a 20-minute break after the completion of charging.

The charged coin cell is disassembled in a glove box (dew point: −70° C. or lower) to prevent short circuits, and the positive electrode is retrieved. The retrieved positive electrode is washed for 10 minutes in dimethyl carbonate (DMC) and is dried in vacuo in a side box. The positive electrode active mix is then scraped off the Al foil using a spatula in the same glove box. A thermogravimetric container made of aluminum is then filled with 15 mg of the positive electrode active mix that has been obtained, and is capped and sealed using a crimper.

The aluminum analysis container obtained in this manner is taken out of the glove box and placed on a balance on the measuring side of a TG-DTA analyzer.

### <TG-DTA Analysis>

Reference: Platinum vessel filled with 15 to 20 mg of Al₂O₃
Maximum temperature: 600° C.
Heating rate:
(1) 25° C. (room temperature) to 50° C.: 1° C./min
(2) 50° C. to 600° C.: 5° C./min
Analytical environment: N₂ gas atmosphere (200 mL/min)

Just before the start of the analysis, a small hole is made in the lid of the sealed aluminum analysis container, which has been placed in the TG-DTA analyzer in an N₂ gas atmosphere, and heating is initiated. The use of this method will allow the analyzed positive electrode active mix powder to be analyzed without being exposed to the atmosphere.

A DTG curve is prepared on the basis of the results that are obtained, where the horizontal axis shows the temperature, and the vertical axis shows the change in weight (TG) over time (derivative thermogravimetry (DTG), meaning the rate of weight loss, which corresponds to the rate of oxygen release from the composite oxide within the range of 150 to 350° C.).

The first peak is defined as the peak showing the greatest derivative thermogravimetric value at the top of the peak among all peaks having a peak top between 150 to 350° C. The derivative thermogravimetry value at the top of the peak is defined as the oxygen release rate (%/min). The second peak is defined as the peak showing the greatest derivative thermogravimetric value at the top of the peak among peaks whose peak tops occur at a temperature at least 20° C. different from the temperature at which the top of the first peak occurs.

The derivative thermogravimetric value at the top of the first peak versus the derivative thermogravimetric value at the top of the second peak is then calculated.

The first peak is the peak showing the greatest derivative thermogravimetric value at the top of the peak within the temperature range of 150 to 350° C. when the DTG curve obtained in the manner noted above is separated into a plurality of peaks.

The derivative thermogravimetric value at the top of the first peak is not particularly limited, but is preferably, for example, 3% or less, 2.9% or less, 2.8% or less, 2.7% or less, 2.6% or less, 2.5% or less, 2.4% or less, 2.3% or less, 2.2% Below, 2.1% or less, or 2% or less.

The second peak is the peak showing the greatest derivative thermogravimetric value at the top of the peak among peaks whose peak tops occur at a temperature at least 20° C. different from the temperature at which the top of the first peak occurs.

The temperature at which the top of the second peak occurs should be at least 20° C. different from the temperature at which the top of the first peak occurs, with no limitations on the height thereof. Specifically, the temperature at which the top of the second peak occurs may be at least 20° C. higher, or at least 20° C. lower, than the temperature at which the top of the first peak occurs.

The temperature at which the top of the second peak occurs is preferably, for example, at least 21° C., at least 22° C., at least 23° C., at least 24° C., at least 25° C., at least 26° C., at least 27° C., at least 28° C., at least 29° C., at least 30° C., at least 31° C., at least 32° C., at least 33° C., at least 34° C., at least 35° C., at least 36° C., at least 37° C., at least 38° C., at least 39° C., or at least 40° C. different from the temperature at which the top of the first peak occurs. The temperature at which the top of the second peak occurs is preferably, for example, no more than 160° C., no more than 155° C., no more than 150° C., no more than 145° C., no more than 140° C., no more than 135° C., no more than 130° C., no more than 125° C., no more than 120° C., no more than 115° C., no more than 110° C., no more than 105° C., no more than 100° C., no more than 95° C., no more than 90° C., no more than 85° C., no more than 80° C., no more than 75° C., or no more than 60° C. different from the temperature at which the top of the first peak occurs.

### <Derivative Thermogravimetric Value Ratio>

In the positive electrode active material of the present disclosure, the derivative thermogravimetric value of the first peak versus the derivative thermogravimetric value of the second peak (derivative thermogravimetric of the first peak/derivative thermogravimetric of the second peak) is not particularly limited, provided that it is 1 to 9, and is preferably, for example, 8.9 or less, 8.8 or less, 8.7 or less, 8.6 or less, 8.5 or less, 8.4 or less, 8.3 or less, 8.2 or less, 8.1 or less, 8 or less, 7.9 or less, 7.8 or less, 7.7 or less, 7.6 or less, 7.5 or less, 7.4 or less, 7.3 or less, 7.2 or less, 7.1 or less, 7 or less, 6.9 or less, 6.8 or less, 6.7 or less, 6.6 or less, 6.5 or less, 6.4 or less, 6.3 or less, 6.2 or less, 6.1 or less, 6 or less, 5.9 or less, 5.8 or less, 5.7 or less, 5.6 or less, 5.5 or less, 5.4 or less, 5.3 or less, 5.2 or less, 5.1 or less, 5 or less, 4.9 or less, 4.8 below, 4.7 or less, 4.6 or less, 4.5 or less, 4.4 or less, 4.3 or less, 4.2 or less, 4.1 or less, 4 or less, 3.9 or less, 3.8 or less, 3.7 or less, 3.6 or less, 3.5 or less, 3.4 or less, 3.3 or less, 3.2 or less, 3.1 or less, 3 or less, 2.9 or less, 2.8 or less, 2.7 or less, 2.6 or less, 2.5 or less, 2.4 or less, 2.3 or less, 2.2 or less, 2.1 or less, 2 or less, 1.9 or less, 1.8 or less, 1.7 or less, or 1.6 or less. On the other hand, the derivative thermogravimetric value of the first peak versus the derivative thermogravimetric value of the second peak may be, 1.1 or more, 1.2 or more, 1.3 or more, 1.4 or more, 1.5 or more, 1.6 or more, 1.7 or more, 1.8 or more, or 1.9 or more.

### <Method for Producing Positive Electrode Active Material for Nonaqueous Electrolyte Secondary Battery>

The positive electrode active material for a nonaqueous electrolyte secondary battery according to an embodiment of the present disclosure can be produced, for example, by carrying out the following steps, in that order. A method for producing the composite oxide containing 30 mol % or more of Ni among elements other than Li is also given as an example below; other methods for producing composite oxides conform to common practice.
Step 1: A precursor composite compound containing at least a transition metal is synthesized, and the precursor composite compound is mixed with a lithium compound to prepare a mixture.
Step 2: The mixture prepared in Step 1 is fired.
Step 3: The composite oxide obtained by firing the mixture in Step 2 is washed with water, as needed.
Step 4: The composite oxide obtained in Step 2 or 3 is surface treated, as needed.
Step 5: Conditions in Steps 1 through 3 are modified, as needed, to mix multiple types of composite oxides in which the primary particle size or average particle size, for example, has been modified.

In Step 1, a precursor composite compound in the form of an aggregate comprising clusters of primary particles that contain at least a transition metal, is first synthesized. The method for synthesizing the precursor composite compound is not particularly limited, and the following method can be used, for example: an aqueous solution (comprising an aqueous solution of a transition metal as well as a variety of aqueous solutions of compounds including other elements, depending on the composition of the intended composite oxide) is added drop-wise into a reaction tank in which an aqueous alkali solution, such as a sodium hydroxide solution or ammonia solution, is stirred as the mother liquor, for example; the pH is monitored and controlled to within a suitable range as sodium hydroxide, for example, is added drop-wise; and co-precipitation is brought about by means of a wet reaction to obtain a product in the form of, for example, a hydroxide, an oxide carbonate obtained by firing the hydroxide, or a carbonate.

In synthesis-related reactions, after the alkaline solution serving as the mother liquor has been prepared, the interior of the reactor is purged with an inert gas or preferably nitrogen gas, for industrial purposes, to create a nitrogen atmosphere in order to keep the oxygen concentration in the reactor or solution as low as possible. If the oxygen concentration is excessively high, there is a risk that the co-precipitated hydroxide will be over-oxidized by any oxygen remaining over the prescribed amount, and a risk that the formation of agglomerates due to crystallization will be compromised.

The transition metal aqueous solution is not particularly limited, although the use of an acidic aqueous solution, for example, is preferred, and the use of a sulfuric acid aqueous solution such as a nickel sulfate aqueous solution is even more preferred in the case of nickel compounds. One or more transition metal aqueous solutions can also be used.

Examples of nickel compounds that can be used include, but are not particularly limited to, one or more selected from nickel sulfate, nickel oxide, nickel hydroxide, nickel nitrate, nickel carbonate, nickel chloride, nickel iodide, and metallic nickel.

Examples of cobalt compounds that can be used include, but are not particularly limited to, one or more selected from cobalt sulfate, cobalt oxide, cobalt hydroxide, cobalt nitrate, cobalt carbonate, cobalt chloride, cobalt iodide, and metallic cobalt

Examples of manganese compounds that can be used include, but are not particularly limited to, one or more selected from manganese sulfate, manganese oxide, manganese hydroxide, manganese nitrate, manganese carbonate, manganese chloride, manganese iodide, and metallic manganese.

Examples of aluminum compounds that can be used include, but are not particularly limited to, aluminum sulfate, aluminum oxide, aluminum hydroxide, aluminum nitrate, aluminum carbonate, aluminum chloride, aluminum iodide, sodium aluminate, and metallic aluminum.

Examples of titanium compounds that can be used include, but are not particularly limited to, titanyl sulfate, titanium oxide, titanium hydroxide, titanium nitrate, titanium carbonate, titanium chloride, titanium iodide, and metallic titanium.

Examples of iron compounds that can be used include, but are not particularly limited to, iron sulfate, iron oxide, iron hydroxide, iron nitrate, iron carbonate, iron chloride, iron iodide, and metallic iron.

Examples of niobium compounds that can be used include, but are not particularly limited to, niobium oxide, niobium chloride, lithium niobate, and niobium iodide.

Examples of tungsten compounds that can be used include, but are not particularly limited to, tungsten oxide, sodium tungstate, ammonium para-tungstate, tungsten hexacarbonyl, and tungsten sulfide.

Examples of magnesium compounds that can be used include, but are not particularly limited to, magnesium sulfate, magnesium oxide, magnesium hydroxide, magnesium nitrate, magnesium carbonate, magnesium chloride, magnesium iodide, and metallic magnesium.

Examples of zinc compounds that can be used include, but are not particularly limited to, zinc sulfate, zinc oxide, zinc hydroxide, zinc nitrate, zinc carbonate, zinc chloride, zinc iodide, and metallic zinc.

Examples of other elements that can be use include one or more selected from sulfates, oxides, hydroxides, nitrates, carbonates, chlorides, iodides, and metals.

The proportions in which the various compounds are blended should be adjusted to ensure the desired proportions of the amounts of the various elements in the composition of the intended composite oxide.

The appropriate pH range for when the precursor composite compound is synthesized is not particularly limited, and can be determined so as to achieve the desired secondary particle size and density, but the pH is generally in the range of around 10 to 13.

The precursor composite compound obtained by means of a wet reaction is preferably subjected to a washing treatment, and then a drying treatment after being de-watered.

Subjecting the precursor composite compound to a washing treatment will make it possible to wash out impurities such as sulfate radicals or carbonate radicals and sodium fractions that have been incorporated into agglomerated particles or that have become stuck on the surface layer during the reaction. Washing treatments that can be used for small amounts of impurities include procedures employing nutsche filtration with a Büchner funnel, or procedures in which the reacted suspension is pumped through a press filter, washed with water, and de-watered. Pure water, a sodium hydroxide aqueous solution, or a sodium carbonate aqueous solution, for example, can be used in the washing treatment, but the use of pure water is preferred for industrial purposes. For sizable residual sulfate radicals, however, a sodium hydroxide aqueous solution in which the pH is controlled according to amount that remains may be used.

The precursor composite compound synthesized in this way and a lithium compound are then mixed in a predetermined ratio to prepare a mixture. The materials may be mixed with the use of a solvent, where the precursor composite compound and the lithium compound are each in the form of a solution, such as an aqueous solution, and the solutions are mixed in a predetermined ratio, or they may be mixed without a solvent, where a powder of the precursor composite compound and a powder of the lithium compound are weighed out in predetermined proportions and mixed by a dry method.

The lithium compound is not particularly limited, and a variety of lithium salts may be used. Specific examples of lithium compounds that can be used include one or more selected from anhydrous lithium hydroxide, lithium hydroxide hydrate, lithium nitrate, lithium carbonate, lithium acetate, lithium bromide, lithium chloride, lithium citrate, lithium fluoride, lithium iodide, lithium lactate, lithium oxalate, lithium phosphate, lithium pyruvate, lithium sulfate, and lithium oxide. Of these, the use of one or more selected from anhydrous lithium hydroxides and lithium hydroxide hydrates is preferred.

The proportions in which the lithium compound and the precursor composite compound are blended are not particularly limited, but should be adjusted, as appropriate, to ensure the desired proportions of the total amounts of the lithium and various other elements in the composition of the intended composite oxide.

In Step 2, when a composite oxide containing at least a transition metal is produced as noted above, a lithiation reaction and crystal growth will occur during the firing process, but the lithiation reaction will require a certain oxygen partial pressure. The lithiation reaction will produce a composite oxide that contains lithium. The temperature is then increased to a prescribed temperature to promote crystal growth.

The mixture is preferably fired to a maximum temperature of 650° C. to 1100° C., 670° C. to 1000° C. or 700° C. to 980° C. The mixture is preferably fired at the maximum temperature for 1 to 24 hours, 1 to 20 hours, 1 to 15 hours, 1 to 10 hours, 2 to 9 hours, or 3 to 8 hours. The desired composite compound can be obtained by establishing the maximum temperature and time at which the firing temperature will be at or higher than the melting point of the lithium compound in the mixture, and at which the composite oxide in which the lithium is contained will result in the desired crystal growth or particle growth.

Firing is commonly carried out by weighing out the lithium compound, the precursor composite compound, and a compound of element M, if needed, mixing the contents in a mixer, and loading the resulting powder mixture into a container such as a crucible or sagger, but it will become more and more difficult for the gas that is produced to be externally discharged and for the required oxygen concentration diffusion to be achieved as one gets closer and closer to the bottom of the container loaded with the powder mixture, in particular, during the lithiation reaction, in particular. As a result, the reaction homogeneity and the primary particle size will become difficult to control.

A method in which primary firing under the prescribed conditions is first preceded by pre-firing under the following prescribed conditions in Step 2 is therefore preferably used when producing the composite oxide according to the embodiment of the present disclosure. Pre-firing is not a mandatory step, however.

Incorporating a firing method that promotes the lithiation reaction is particularly desirable for the pre-firing in Step 2. A specific example is a method that will allow the mixture to be easily heated, allow the gas that is generated to be easily discharged from the lithium compound, and allow gas having a high oxygen partial pressure to be diffused into the mixture (inside the particles). The desired properties can be achieved by, for example, pre-firing less of the mixture.

For the pre-firing process in Step 2, the mixture can be loaded into a sagger or crucible and fired in a static furnace, roller hearth kiln, or pusher furnace, but a rotary kiln in which the mixture is fired while flowing can also be used.

The maximum temperature of the mixture being pre-fired is not particularly limited, and is preferably adjusted depending on the type of lithium compound that is being used to prepare the mixture. This can ensure a reliable reaction between the precursor composite compound and lithium compound in the mixture as well as reliable and homogeneous lithiation reaction progress in order to prevent the occurrence of foreign phases and thus allow the desired composite oxide to be obtained.

The pre-firing atmosphere is not particularly limited, and should be an oxidizing atmosphere that ensures reliable and homogeneous lithiation reaction progress. For example, the use of an oxidative decarboxylation gas atmosphere having a carbon dioxide gas concentration of 30 ppm or less or an oxygen atmosphere having an oxygen concentration of 80 vol % to 90 vol % is preferred.

The pre-firing time is not particularly limited, and should be a time that ensures reliable and homogeneous lithiation reaction progress. For example, a time of 1 to 10 hours or 2 to 8 hours is preferred.

Primary firing of the pre-fired mixture is carried out in order to bring about crystal growth or particle growth at a higher temperature. Reliable and homogeneous crystal growth progress is required at this time to obtain a composite oxide having a desired crystal structure.

The primary firing atmosphere is not particularly limited, and should be an atmosphere that has an oxygen partial pressure, and preferably a low moisture content or carbon dioxide gas concentration, that will ensure reliable and homogeneous crystal growth, without reducing the transition metal contained in the mixture that is being fired. For example, the use of an oxidative decarboxylation gas atmosphere having a carbon dioxide gas concentration of 30 ppm or less or an oxygen atmosphere having an oxygen concentration of 80 vol % to 90 vol % is preferred.

The primary firing temperature is not particularly limited, provided that it is higher than the pre-firing temperature, but can be adjusted depending on the composition, for example, of the composite oxide that is going to be obtained. The maximum temperature is preferably adjusted to between 700° C. and 1100° C., between 710° C. and 1000° C., or between 720° C. to 980° C., for example. A maximum temperature within the prescribed range will make it possible to obtain a composite oxide that has the desired crystal structure, with fewer unreacted components, and to prevent the loss of the battery characteristics of the nonaqueous electrolyte secondary batteries in which the resulting composite oxide is used as the positive electrode. To obtain, for example, a composite oxide having a Ni content of 20 mol % to 80 mol % among elements other than Li, the mixture is preferably fired at a maximum temperature not to exceed 1100° C.

The primary firing time is not particularly limited, and should be enough time to form a composite oxide having the desired crystal structure. For example, a time of 1 to 15 hours, 2 to 12, hours, or 2 to 10 hours is preferred.

In Step 3, the composite oxide obtained in Step 2 may contain unreacted lithium compounds or lithium compounds that have moved from the crystal structure to the particle surface layer over the course of the firing step. A water washing and heat treatment can therefore be performed, for example, in order to remove or minimize such impurities. Step 3 is not mandatory.

In Step 4, a prescribed elemental compound is added to, and mixed with, the composite oxide obtained in Step 2 or 3, and a heat treatment is carried out to allow the surface of the primary particles and/or secondary particles of the composite oxide to be surface treated with a compound of lithium and the added elements, making it possible to leave fewer lithium compounds on the particle surface layer, to improve lithium ion conductivity, and to lower reaction resistance, for example. Step 4 is not mandatory.

The elemental compound added for the surface treatment noted above can be selected, for example, from aluminum compounds, boron compounds, tungsten compounds, manganese compounds, cobalt compounds, phosphorus compounds, niobium compounds, strontium compounds, antimony compounds, zirconium compounds, and titanium compounds, where one or more can be used.

When, for example, the composite oxide obtained in any of steps 2 through 4 does not by itself have the plurality of specific peaks noted above, or the specific requirements for the specific peaks are satisfied but more effective control of thermal runaway is desired, the conditions for producing the composite oxide (Steps 1 through 4) are modified to mix multiple types of composite oxides in which the primary particle size or average particle size has been modified, which is Step 5. This step is not mandatory if the composite oxide obtained in any of steps 2 through 4 does by itself satisfy the specific requirements for specific peaks.

### <Nonaqueous Electrolyte Secondary Battery>

The nonaqueous electrolyte secondary battery according to the embodiment of the present disclosure comprises a positive electrode that contains the above composite oxide as the positive electrode active material, wherein the nonaqueous electrolyte secondary battery comprises a positive electrode, a negative electrode, and an electrolytic solution comprising an electrolyte.

When the positive electrode is produced, a conductor and a binder are added to, and mixed with, the composite oxide according to the embodiment of the present disclosure in the usual manner. The use of acetylene black, carbon black, and graphite, for example, is preferred as the conductor. The use of polytetrafluoroethylene and polyvinylidene fluoride, for example, is preferred as the binder.

Examples of active materials that can be used for the negative electrode include, but are not particularly limited to, negative electrode active materials such as lithium metal, graphite, and low-crystallinity carbon materials, as well as one or more non-metal or metal elements selected from the group consisting of Si, Al, Sn, Pb, Zn, Bi and Cd, or alloys comprising the same, or chalcogen compounds comprising the same.

Examples of solvents that can be used for the electrolytic solution include, but are not particularly limited to, organic solvents including one or more carbonates, such as ethylene carbonate, propylene carbonate, dimethyl carbonate, and diethyl carbonate, or ethers such as dimethoxyethane.

In addition to, in particular, lithium hexafluorophosphate (LiPF₆), one or more selected from lithium salts such as lithium perchlorate or lithium tetrafluoroborate can be used, while dissolved in a solvent, as the electrolyte.

### EXAMPLE

The present disclosure is illustrated in greater detail below using examples but is not limited to these examples.

### <Preparation of Composite Oxide Samples>

The composite oxide materials of Examples 1 through 13 and Comparative Example 1 were prepared by the following methods.

Preparation of Precursor Composite Hydroxide 1: A nickel sulfate aqueous solution as well as cobalt sulfate and manganese sulfate aqueous solution were mixed to an Ni and Co and Mn ratio (molar ratio) of Ni:Co:Mn=83:5:12, giving an aqueous solution mixture. 10 L of pure water to which 300 g of a sodium hydroxide aqueous solution and 500 g of aqueous ammonia had been added was prepared in advance as the mother liquor in a reactor, the interior of the reactor was purged with nitrogen gas at a flow rate of 0.7 L/min to create a nitrogen atmosphere, and the reaction was also carried out under a nitrogen atmosphere.

The aqueous solution mixture, the sodium hydroxide aqueous solution, and the aqueous ammonia were then simultaneously added drop-wise at a predetermined rate as a stirring blade was rotated at 1000 rpm, and the Ni, Co and Mn were co-precipitated by being crystallized into particle aggregates through a crystallization reaction in which the amount of the alkaline solution drops was adjusted to a pH of 11.5, thus giving a co-precipitate.

The slurry inside the reactor was then separated into liquid and solids, which were washed with pure water to lower residual impurities, and the co-precipitate in the form of caked was then dried for 10 hours at 100° C. in the atmosphere to obtain a nickel-cobalt-manganese composite hydroxide represented by the compositional formula Ni_{0.83}Co_{0.05}Mn_{0.12}(OH)₂. The D50 of the resulting composite hydroxide precursor was 14.2 μm.

Preparation of Precursor Composite Hydroxide 2: A nickel sulfate aqueous solution as well as cobalt sulfate and manganese sulfate aqueous solution were mixed to an Ni and Co and Mn ratio (molar ratio) of Ni:Co:Mn=83:12:5, giving an aqueous solution mixture. 10 L of pure water to which 330 g of a sodium hydroxide aqueous solution and 500 g of aqueous ammonia had been added was prepared in advance as the mother liquor in a reactor, the interior of the reactor was purged with nitrogen gas at a flow rate of 0.7 L/min to create a nitrogen atmosphere, and the reaction was also carried out under a nitrogen atmosphere.

The aqueous solution mixture, the sodium hydroxide aqueous solution, and the aqueous ammonia were then simultaneously added drop-wise at a predetermined rate as a stirring blade was rotated at 1100 rpm, and the Ni, Co and Mn were co-precipitated by being crystallized into particle aggregates through a crystallization reaction in which the amount of the alkaline solution drops was adjusted to a pH of 12.6, thus giving a co-precipitate.

The slurry inside the reactor was then separated into liquid and solids, which were washed with pure water to lower residual impurities, the co-precipitate in the form of caked was then dried for 10 hours at 100° C. in the atmosphere, and a nickel-cobalt-manganese composite hydroxide represented by the compositional formula Ni_{0.83}Co_{0.12}Mn_{0.05}(OH)₂ was obtained via co-precipitation. The D50 of the resulting composite hydroxide precursor was 4.0 μm.

### Example 1

The precursor composite hydroxide 1, lithium hydroxide, and aluminum hydroxide were weighed out to Li/(Ni+Co+Mn+Al)=1.030 and AI/(Ni+Co+Mn+Al)=2.0 mol %, and were mixed. The mixture was then heat treated for 6 hours at 570° C. in an oxygen atmosphere, and then fired for 6 hours at 805° C. in an oxygen atmosphere (oxygen concentration: 97 vol %). The resulting fired product was milled to obtain a lithium-nickel composite oxide powder.

The resulting lithium-nickel composite oxide powder was mixed with pure water (adjusted to a liquid temperature of 25° C.) to a water ratio of 1500 g/L, and the resulting slurry was stirred for 10 minutes and then de-watered to obtain a compound in the form of cake. The compound in the form of cake was dried for 2 hours at 75° C. and 10 hours at 120° C. in a vacuum dryer.

As the boron compound, boric acid was added (1000 ppm) to, and mixed with, the dried lithium-nickel composite oxide, and the mixture was heat treated for 2 hours at 325° C. in an oxygen atmosphere (oxygen concentration: 97 vol %) to obtain the composite oxide sample of Example 1. The Li/(Ni+Co+Mn+Al) ratio of the resulting composite oxide sample was 1.009.

### Example 2

The composite oxide sample of Example 2 was obtained in the same manner as in Example 1, except that the precursor composite hydroxide 1, lithium hydroxide, and aluminum hydroxide were weighed out to Li/(Ni+Co+Mn+Al)=1.050 and AI/(Ni+Co+Mn+Al)=2.0 mol %. The Li/(Ni+Co+Mn+Al) ratio of the resulting composite oxide sample was 1.023.

### Example 3

The composite oxide sample of Example 3 was obtained in the same manner as in Example 1, except that the precursor composite hydroxide 1, lithium hydroxide, and aluminum hydroxide were weighed out to Li/(Ni+Co+Mn+Al)=1.070 and AI/(Ni+Co+Mn+Al)=2.0 mol %. The Li/(Ni+Co+Mn+Al) ratio of the resulting composite oxide sample was 1.045.

### Example 4

The composite oxide sample of Example 4 was obtained in the same manner as in Example 1, except that the precursor composite hydroxide 1, lithium hydroxide, and aluminum hydroxide were weighed out to Li/(Ni+Co+Mn+Al)=1.090 and AI/(Ni+Co+Mn+Al)=2.0 mol %. The Li/(Ni+Co+Mn+Al) ratio of the resulting composite oxide sample was 1.06.

### Example 5

The precursor composite hydroxide 1, lithium hydroxide, and aluminum hydroxide were weighed out to Li/(Ni+Co+Mn+Al)=1.010 and AI/(Ni+Co+Mn+Al)=3.0 mol %, and were mixed. The mixture was then heat treated for 6 hours at 570° C. in an oxygen atmosphere, and then fired for 6 hours at 810° C. in an oxygen atmosphere (oxygen concentration: 97 vol %). The resulting fired product was milled to obtain a lithium-nickel composite oxide. The composite oxide sample of Example 5 was then obtained in the same manner as in Example 1. The Li/(Ni+Co+Mn+Al) ratio of the resulting composite oxide sample was 1.001.

### Example 6

The composite oxide sample of Example 6 was obtained in the same manner as in Example 5, except that the precursor composite hydroxide 1, lithium hydroxide, and aluminum hydroxide were weighed out to Li/(Ni+Co+Mn+Al)=1.030 and AI/(Ni+Co+Mn+Al)=3.0 mol %. The Li/(Ni+Co+Mn+Al) ratio of the resulting composite oxide sample was 1.012.

### Example 7

The composite oxide sample of Example 7 was obtained in the same manner as in Example 5, except that the precursor composite hydroxide 1, lithium hydroxide, and aluminum hydroxide were weighed out to Li/(Ni+Co+Mn+Al)=1.050 and AI/(Ni+Co+Mn+Al)=3.0 mol %. The Li/(Ni+Co+Mn+Al) ratio of the resulting composite oxide sample was 1.032.

### Example 8

The composite oxide sample of Example 8 was obtained in the same manner as in Example 5, except that the precursor composite hydroxide 1, lithium hydroxide, and aluminum hydroxide were weighed out to Li/(Ni+Co+Mn+Al)=1.030 and AI/(Ni+Co+Mn+Al)=1.0 mol %. The Li/(Ni+Co+Mn+Al) ratio of the resulting composite oxide sample was 1.008.

### Example 9

The precursor composite hydroxide 2 and lithium hydroxide were weighed out to Li/(Ni+Co+Mn)=1.050, and were mixed. The mixture was then fired for 12 hours at 860° C. in an oxygen atmosphere (oxygen concentration: 97 vol %). The resulting fired product was milled to obtain a lithium-nickel composite oxide powder.

The resulting lithium-nickel composite oxide powder was fired for another 7 hours at 700° C. in an oxygen atmosphere (oxygen concentration: 97 vol %).

As the boron compound, boric acid was added (500 ppm) to, and mixed with, the fired lithium-nickel composite oxide, and the mixture was heat treated for 7 hours at 330° C. in the atmosphere to obtain the composite oxide sample of Example 9. The Li/(Ni+Co+Mn) ratio of the resulting composite oxide sample was 1.015.

### Example 10

The composite oxide sample of Example 10 was obtained in the same manner as in Example 9, except that the precursor composite hydroxide 2 and lithium hydroxide were weighed out to Li/(Ni+Co+Mn)=1.060. The Li/(Ni+Co+Mn) ratio of the resulting composite oxide sample was 1.029.

### Example 11

The composite oxide sample of Example 11 was obtained in the same manner as in Example 9, except that the precursor composite hydroxide 2 and lithium hydroxide were weighed out to Li/(Ni+Co+Mn)=1.070. The Li/(Ni+Co+Mn) ratio of the resulting composite oxide sample was 1.048.

### Example 12

The precursor composite hydroxide 2 and lithium hydroxide were weighed out to Li/(Ni+Co+Mn)=1.070, and were mixed. The mixture was then fired for 12 hours at 860° C. in an oxygen atmosphere (oxygen concentration: 97 vol %). The resulting fired product was milled to obtain a lithium-nickel composite oxide powder.

Aluminum oxide powder (Al₂O₃) was added (0.5 mol %) to the resulting lithium-nickel composite oxide powder, and the mixture was heat treated for 7 hours at 700° C. in the atmosphere. The composite oxide sample of Example 12 was then obtained in the same manner as in Example 9. The Li/(Ni+Co+Mn+Al) ratio of the resulting composite oxide sample was 1.012.

### Example 13

The precursor composite hydroxide 2 and lithium hydroxide were weighed out to Li/(Ni+Co+Mn)=1.050, and were mixed. The mixture was then fired for 12 hours at 860° C. in an oxygen atmosphere (oxygen concentration: 97 vol %). The resulting fired product was milled to obtain a lithium-nickel composite oxide powder.

Aluminum oxide powder (Al₂O₃) was added (0.8 mol %) to the resulting lithium-nickel composite oxide powder, and the mixture was heat treated for 7 hours at 600° C. in the atmosphere to obtain a lithium metal composite oxide.

The heat-treated lithium-nickel composite oxide powder was mixed with pure water (adjusted to a liquid temperature of 25° C.) to a water ratio of 1500 g/L, and the resulting slurry was stirred for 10 minutes and then de-watered to obtain a compound in the form of cake. The compound was dried for 2 hours at 75° C. and 10 hours at 120° C. in a vacuum dryer.

Boric acid was added (500 ppm) as the boron compound to, and mixed with, the dried lithium-nickel composite oxide, and the mixture was heat treated for 7 hours at 300° C. in the atmosphere to obtain the composite oxide sample of Example 13. The Li/(Ni+Co+Mn+Al) ratio of the resulting composite oxide sample was 0.989.

### Comparative Example 1

The precursor composite hydroxide 2, lithium hydroxide, and aluminum hydroxide were weighed out to Li/(Ni+Co+Mn+Al)=1.050, and were mixed. The mixture was then fired for 12 hours at 860° C. in an oxygen atmosphere (oxygen concentration: 97 vol %). The resulting fired product was milled to obtain a lithium-nickel composite oxide powder.

Aluminum oxide powder (Al₂O₃) was added (0.8 mol %) to the resulting lithium-nickel composite oxide powder, and the mixture was heat treated for 7 hours at 700° C. in the atmosphere. The composite oxide sample of Comparative Example 1 was then obtained in the same manner as in Example 9. The Li/(Ni+Co+Mn+Al) ratio of the resulting composite oxide sample was 1.

The samples were assessed in the following manner.

### <Compositional Analysis of Precursor Compounds and Composite Oxides>

The compositions of the precursor composite compounds and composite oxide samples were determined by the following method. Composite oxide samples (0.2 g) were heated and dissolved in 25 mL of 20% hydrochloric acid solution, the sample solutions were cooled and then transferred to 100 mL measuring flasks, and pure water was introduced to adjust the solutions. An ICP-AES (Optima 8300, by PerkinElmer) was used for elemental quantification of the adjusted solutions.

### <Average Particle Size (D50) of Precursor Compound>

This was determined on a volume basis by a wet laser method using a laser type particle size distribution analyzer (Microtrac HRA, manufactured by Nikkiso Co., Ltd.).

### <Thermogravimetric-Differential Thermal Analysis>

Thermogravimetric differential thermal analysis (TG-DTA) was performed using a thermogravimetric differential thermal analysis (TG-DTA) device (DTG-60H, by Shimadzu Corporation) in order to confirm the behavior of oxygen release from the composite oxide sample.

### <Sample Preparation>

2032 type coin cells having a lithium counter electrode were produced in accordance with the method described below, and were charged at a constant current of 0.3 C to 4.30 V at a temperature of 25° C. and then charged at at constant voltage to a current value of 0.05 C. After a 20-minute break following the completion of charging, the coin cells were discharged at a constant current of 0.3 C to 2.50 V, and were then discharged at a constant current of 0.1 C, followed by a 20-minute break. The charging and discharging were repeated twice. The coin cells were then charged at a constant current of 0.3 C to 4.30 V, and then charged at a constant voltage to a current value of 0.05 C, followed by a 20-minute break after the completion of charging.

The charged coin cells were disassembled in a glove box (dew point: −70° C. or lower) to prevent short circuits, and the positive electrodes were retrieved. The retrieved positive electrodes were washed for 10 minutes in DMC and were dried in vacuo in a side box. The positive electrode active mix was then scraped off the Al foil using a spatula in the same glove box. Thermogravimetric containers made of aluminum were then filled with 15 mg of the positive electrode active mix that had been obtained, and were capped and sealed using a crimper.

The aluminum analysis containers obtained in this manner were taken out of the glove box and placed on a balance on the measuring side of a TG-DTA analyzer.

### <TG-DTA Analysis>

Reference: Platinum vessel filled with 15 to 20 mg of Al₂O₃
Maximum temperature: 600° C.
Heating rate:
(1) 25° C. (room temperature) to 50° C.: 1° C./min
(2) 50° C. to 600° C.: 5° C./min
Analytical environment: N₂ gas atmosphere (200 mL/min)

Just before the start of the analysis, a small hole was made in the lids of the sealed aluminum analysis containers, which had been placed in the TG-DTA analyzer in an N₂ gas atmosphere, and heating was initiated.

A DTG curve is prepared on the basis of the results that are obtained, where the horizontal axis shows the temperature, and the vertical axis shows the change in weight (TG) over time (derivative thermogravimetry (DTG), meaning the rate of weight loss, which corresponds to the rate of oxygen release from the composite oxide within the range of 150 to 350° C.).

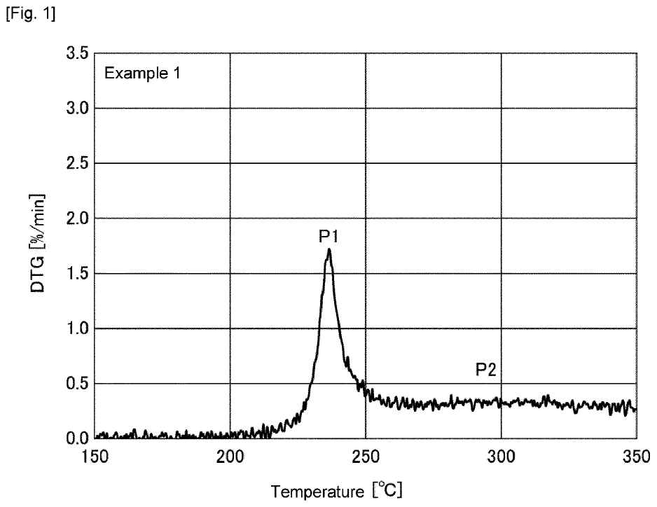

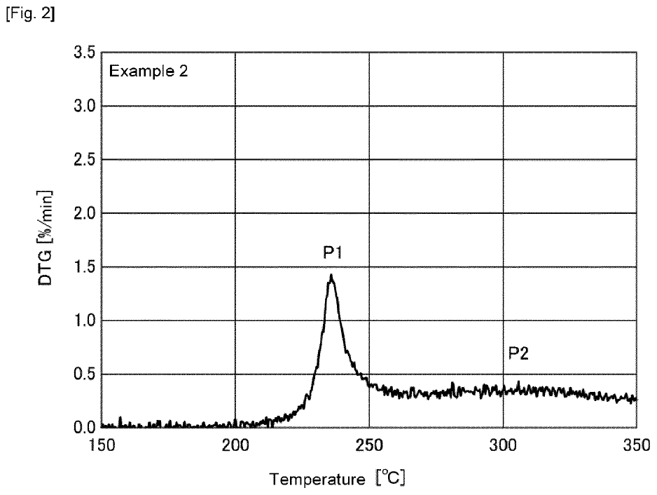

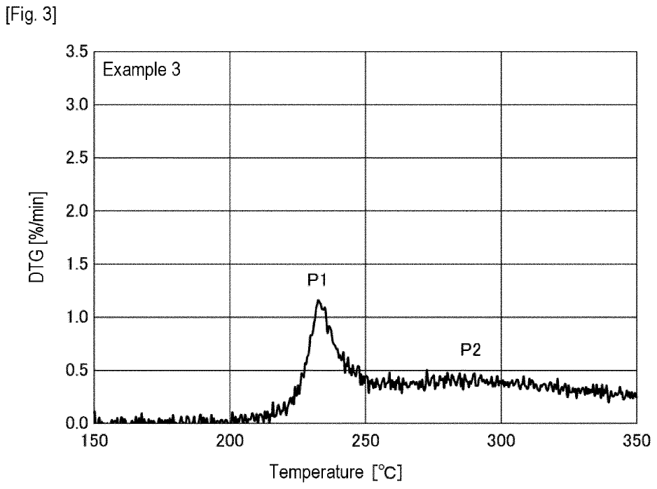

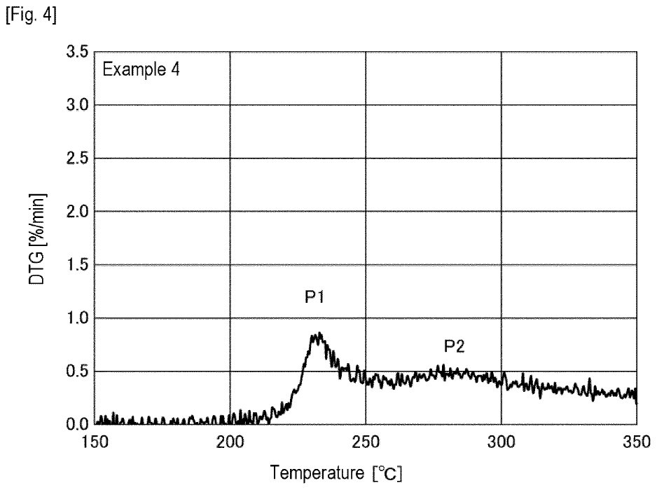

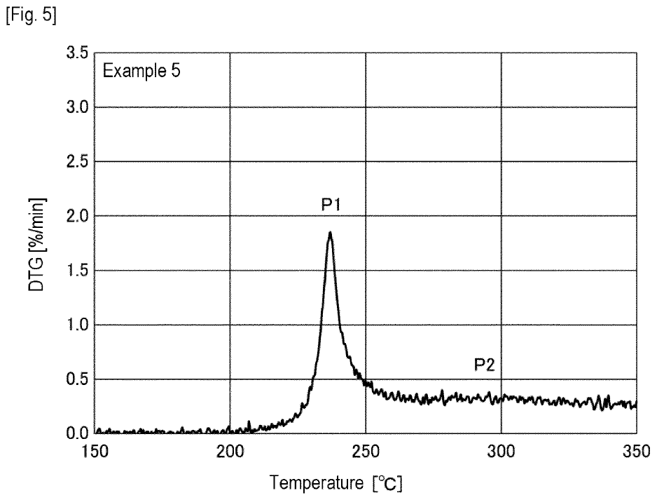

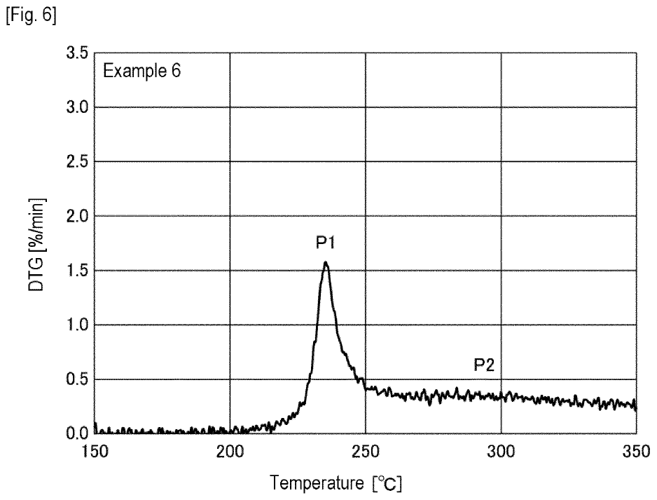

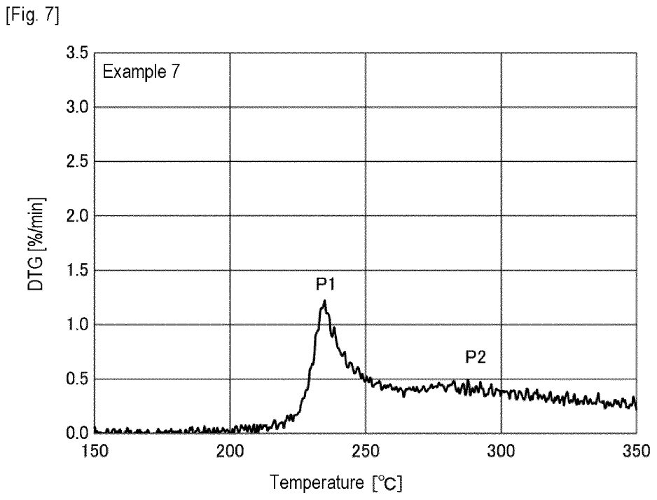

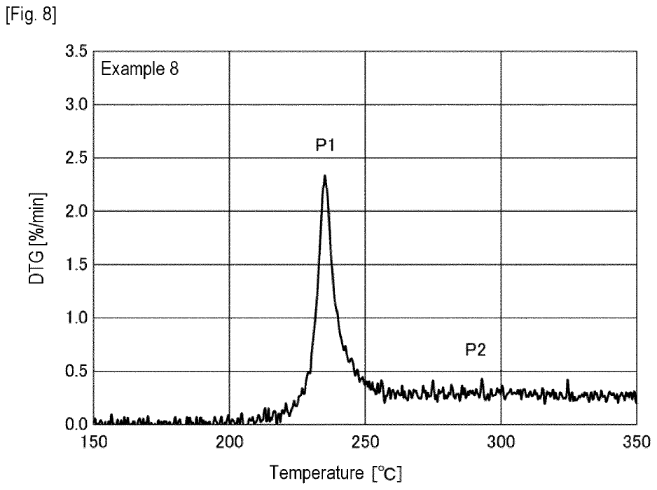

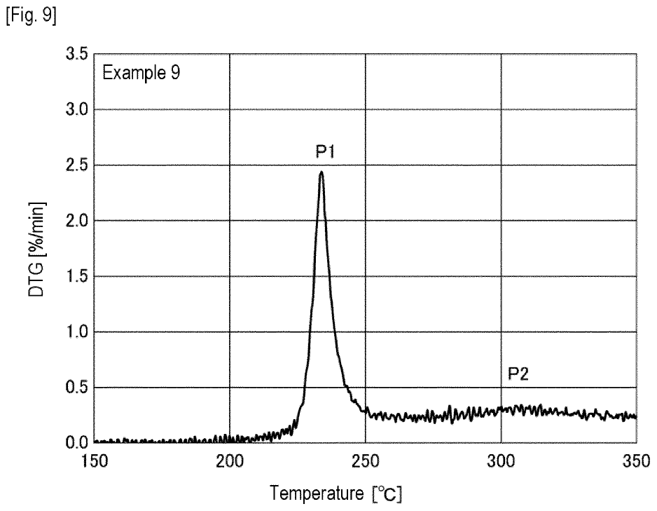

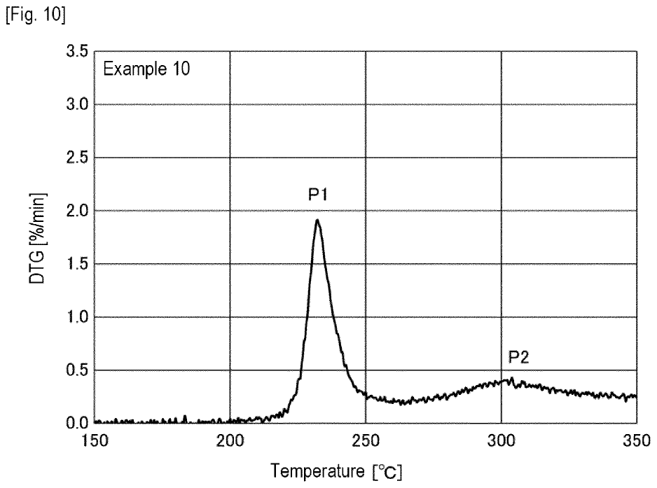

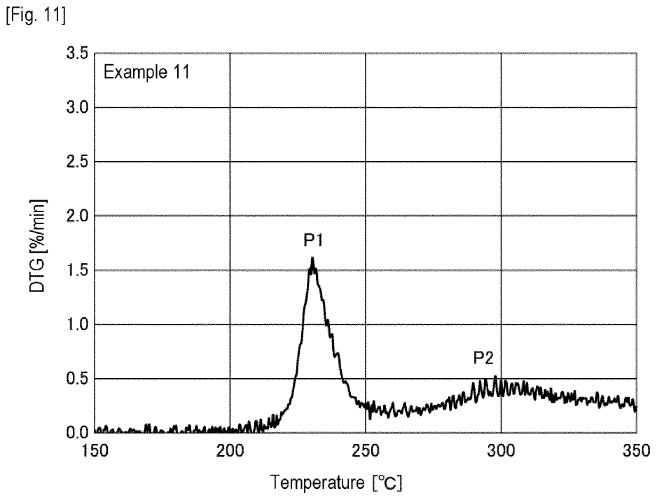

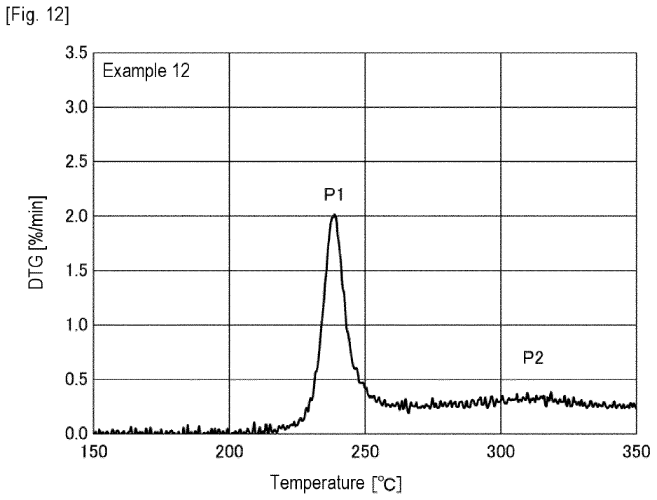

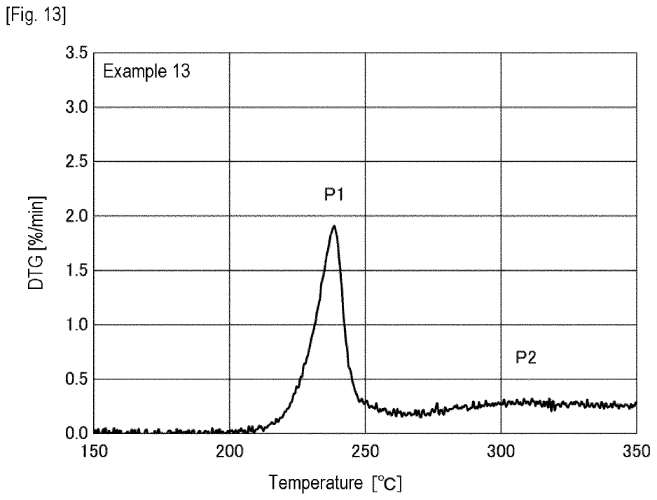

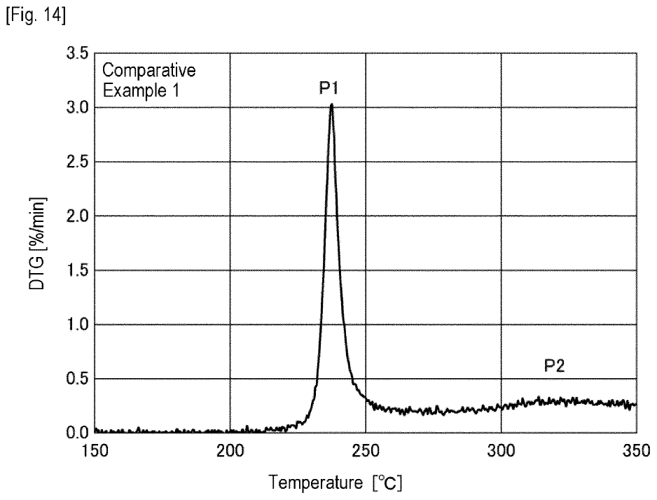

The first peak (P1) was defined as the peak showing the greatest derivative thermogravimetric value at the top of the peak among all peaks having a peak top between 150 to 350° C. The derivative thermogravimetry value at the top of the peak was defined as the oxygen release rate (%/min). The second peak (P2) was defined as the peak showing the greatest derivative thermogravimetric value at the top of the peak among peaks whose peak tops occurred at a temperature at least 20° C. different from the temperature at which the top of the first peak occurred. FIGS. 1 through 13 are DTG curves of samples of the composite oxide materials of Examples 1 through 13. FIG. 14 is a DTG curve of a sample of the composite oxide material of Comparative Example 1.

### <Analysis of Crystal Structures by Rietveld Analysis>

XRD diffraction data of the positive electrode active material was obtained under the following X-ray diffraction conditions using an X-ray diffraction apparatus [SmartLab, produced by Rigaku Corp.], and the XRD diffraction data was then subjected to Rietveld analysis, with reference to “R. A. Young, ed., “The Rietveld Method”, Oxford University Press (1992).” Specifically, the proportion of lithium contained at the 3a site and the 3b site, as well as the unit cell volume were calculated.

### <X-Ray Diffraction Conditions>

X-ray source: Cu-Kα
Acceleration voltage and current: 45 kV and 200 mA
Sampling width: 0.02 deg.
Scan width: 15 deg. to 122 deg.
Scan speed: 1.0 steps/see
Divergence slit: 2/3 deg.
Receiving slit width: 0.15 mm
Scattering slit: 2/3 deg.

### <Assessment of Coin Cell Charge Capacity Using Composite Oxide Samples>

In the present specification, 2032 type coin cells in which composite oxide samples were used as positive electrode active material were produced using positive electrodes, negative electrodes, and electrolytic solutions prepared by the following methods.

The positive electrode active material, conductor (acetylene black:graphite weight ratio of 1:1), and binder (polyvinylidene fluoride) were blended in a positive electrode active material:conductor:binder weight ratio of 90:6:4, and a mixture of these materials with N-methylpyrrolidone was applied onto aluminum foil. The foil was dried at 110° C. to prepare a sheet, which was punched to a diameter of 15 mm and then rolled at 3 t/cm² to produce a positive electrode.

A lithium foil having a thickness of 500 μm punched to a diameter of 16 mm was used as the negative electrode.

A solvent mixture of ethylene carbonate (EC) and dimethyl carbonate (DMC) prepared to an EC:DMC volume ratio of 1:2 was mixed with 1 mol/L of LiPF₆ electrolyte for use as the electrolytic solution.

A 0.5 mm thick separator (Celgard #2400, manufactured by Celgard) that had been punched to a size of 20 mm was used.

The coin cells produced by the method above were charged at a constant current of 0.3 C to 4.30 V at a temperature of 25° C. and then charged at a constant voltage to a current value of 0.05 C. After a 20-minute break following the completion of charging, the coin cells were discharged at a constant current of 0.3 C to 2.50 V, and were then discharged at constant current of 0.1 C, followed by a 20-minute break. The charging and discharging were repeated twice. The coin cells were then charged at a constant current of 0.3 C to 4.30 V, and then charged at a constant voltage to a current value of 0.05 C. The total charging capacity (mAh/g) was calculated as follows.

### First Charge/Discharge

To 4.3 V at a current of 0.3 C (constant voltage charging to 0.05 C) 20-Minute break
Discharge at current of 0.3 C to 2.5 V and then at a current of 0.1 C to 2.5 V 20-Minute break

### Second Charge/Discharge

To 4.3 V at a current of 0.3 C (constant voltage charging to 0.05 C) 20-Minute break
Discharge at current of 0.3 C to 2.5 V and then at a current of 0.1 C to 2.5 V

### Third Charge/Discharge

To 4.3 V at a current of 0.3 C (constant voltage charging to 0.05 C)

Total charge capacity=first charge capacity+(second charge capacity−first discharge capacity at 0.3 C−first discharge capacity at 0.1 C)+(third charge capacity−second discharge capacity at 0.3 C−second discharge capacity at 0.1 C)

Table 1 shows the compositions of the composite oxides constituting the samples of Examples 1 through 13 and Comparative Example 1, the proportions of lithium contained at the 3a site and the 3b site, the unit cell volume, the total charging capacity, the temperature at the top of the first peak on the DTG curve, the derivative thermogravimetric value (oxygen release rate) and percent decrease in derivative thermogravimetric value relative to Comparative Example 1, the temperature and derivative thermogravimetric value (oxygen release rate) at the top of second peak, and the ratio of the thermogravimetric value at the top of the first peak relative to the thermogravimetric value at the top of the second peak (derivative thermogravimetric value at the top of the first peak/derivative thermogravimetric value at the top of the second peak).

TABLE 1

| | Composite oxide composition | | | | | | | | | | |
|---|---|---|---|---|---|---|---|---|---|---|---|
| | Composite Oxide 1 | | Composite Oxide 2 | | | | | | | | |
| | | Al | | Al | | | | | | | |
| | | substitution | | substitution | | | | | | Assessment results | |
| | Li/M | (mol %) | Li/M | (mol %) | x | 1-y-z-w | y | z | w | Li in 3b | Li in 3a |
| Example 1 | 1.009 | 2 | | | 0.0090 | 0.810 | 0.050 | 0.120 | 0.020 | 0.064 | 0.972 |
| Example 2 | 1.023 | 2 | | | 0.0230 | 0.810 | 0.050 | 0.120 | 0.020 | 0.067 | 0.972 |
| Example 3 | 1.045 | 2 | | | 0.0450 | 0.810 | 0.050 | 0.120 | 0.020 | 0.070 | 0.976 |
| Example 4 | 1.06 | 2 | | | 0.0600 | 0.810 | 0.050 | 0.120 | 0.020 | 0.072 | 0.979 |
| Example 5 | 1.001 | 3 | | | 0.0010 | 0.800 | 0.050 | 0.120 | 0.030 | 0.058 | 0.967 |
| Example 6 | 1.012 | 3 | | | 0.0120 | 0.800 | 0.050 | 0.120 | 0.030 | 0.066 | 0.971 |
| Example 7 | 1.032 | 3 | | | 0.0320 | 0.800 | 0.050 | 0.120 | 0.030 | 0.071 | 0.977 |
| Example 8 | 1.008 | 1 | | | 0.0080 | 0.820 | 0.050 | 0.120 | 0.010 | 0.056 | 0.967 |
| Example 9 | | | 1.015 | 0 | 0.0150 | 0.830 | 0.120 | 0.050 | 0.000 | 0.041 | 0.987 |
| Example 10 | | | 1.029 | 0 | 0.0290 | 0.830 | 0.120 | 0.050 | 0.000 | 0.043 | 0.990 |
| Example 11 | | | 1.048 | 0 | 0.0480 | 0.830 | 0.120 | 0.050 | 0.000 | 0.048 | 0.986 |
| Example 12 | | | 1.012 | 2 | 0.0120 | 0.810 | 0.120 | 0.050 | 0.020 | 0.042 | 0.987 |
| Example 13 | | | 0.989 | 0.6 | −0.0110 | 0.824 | 0.120 | 0.050 | 0.006 | 0.048 | 0.986 |
| Comparative | | | 1 | 0.8 | 0.0000 | 0.822 | 0.120 | 0.050 | 0.008 | 0.050 | 0.986 |
| Example 1 | | | | | | | | | | | |

| Assessment results | | | |
|---|---|---|---|
| | First peak | | |
| | | Oxygen | |
| | | release | |
| | | Rate (percent | Second peak |

| | | Total | | Oxygen | reduced) vs. | | Oxygen | Peak ratio |
|---|---|---|---|---|---|---|---|---|
| | | charge | Peak top | release | Comparative | Peak top | release | (first peak/ |
| | Unit cell | capacity | temperature | rate | Example 1 | temperature | rate | Second |
| | Volume | [mAh/g] | [° C.] | [%/min] | [%] | [° C.] | [%/min] | peak) |
| Example 1 | 101.89 | 226 | 237 | 1.72 | 57% | 282 | 0.394 | 4.4 |
| Example 2 | 101.82 | 225 | 236 | 1.428 | 47% | 281 | 0.418 | 3.4 |
| Example 3 | 101.71 | 226 | 233 | 1.16 | 38% | 273 | 0.502 | 2.3 |
| Example 4 | 101.65 | 224 | 233 | 0.863 | 28% | 279 | 0.559 | 1.5 |
| Example 5 | 101.90 | 230 | 237 | 1.848 | 61% | 278 | 0.396 | 4.7 |
| Example 6 | 101.82 | 231 | 235 | 1.578 | 52% | 284 | 0.422 | 3.7 |
| Example 7 | 101.70 | 231 | 235 | 1.218 | 40% | 288 | 0.49 | 2.5 |
| Example 8 | 101.98 | 232 | 235 | 2.334 | 77% | 293 | 0.427 | 5.5 |
| Example 9 | 101.44 | 231 | 234 | 2.438 | 80% | 307 | 0.341 | 7.1 |
| Example 10 | 101.38 | 229 | 232 | 1.915 | 63% | 304 | 0.43 | 4.5 |
| Example 11 | 101.36 | 229 | 230 | 1.612 | 53% | 298 | 0.521 | 3.1 |
| Example 12 | 101.39 | 228 | 239 | 2.016 | 67% | 319 | 0.383 | 5.3 |
| Example 13 | 101.53 | 232 | 239 | 1.908 | 63% | 311 | 0.318 | 6.0 |
| Comparative | 101.40 | 232 | 238 | 3.03 | 100% | 314 | 0.334 | 9.1 |
| Example 1 | | | | | | | | |

1. A positive electrode active material for a nonaqueous electrolyte secondary battery comprising a composite oxide represented by general formula 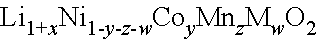
wherein M is one or more elements other than Li, Ni, Co, Mn, 0; −0.1≤x≤0.15, 0≤y≤0.4, 0≤z≤0.4, and 0≤w≤0.1, when a derivative thermogravimetric curve is obtained after a sample of the composite oxide, charged to 4.30 V using lithium as the counter electrode, heated from 50° C. to 600° C. at a rate of 5° C./min, and the resulting curve is separated into a plurality of peaks, wherein within the temperature range of from 150° C. to 350° C., the top of the first peak shows the greatest derivative thermogravimetric value and the top of the second peak shows the greatest derivative thermogravimetric value among peaks whose peak tops occur at a temperature at least 20° C. different from the temperature at which the top of the first peak occurs, and the derivative thermogravimetric value at the top of the first peak is 1 to 9 times the derivative thermogravimetric value at the top of the second peak.

2. The positive electrode active material for a nonaqueous electrolyte secondary battery according to claim 1, wherein in the composite oxide, 0≤x≤0.15.

3. The positive electrode active material for a nonaqueous electrolyte secondary battery according to claim 1, wherein the derivative thermogravimetric value at the top of the first peak is 3%/min or less.

4. A nonaqueous electrolyte secondary battery, comprising the positive electrode containing the positive electrode active material according to claim 1.
